(19) United States
(12) Patent Application Publication
(10) Pub. No.: US 2024/0407364 A1
(43) Pub. Date: Dec. 12, 2024

(54) METHODS OF WEED CONTROL

(71) Applicant: Weedout Ltd., Nes Ziona (IL)

(72) Inventors: Yuval KADAN, Rehovot (IL); Efrat LIDOR-NILI, Nes Ziona (IL); Orly NOIVIRT-BRIK, Givataim (IL); Ido SHWARTZ, Herzeliya (IL); Amit KOCH, Rehovot (IL); Jonathan GRESSEL, Rehovot (IL)

(73) Assignee: Weedout Ltd., Nes Ziona (IL)

(21) Appl. No.: 18/701,282

(22) PCT Filed: Oct. 13, 2022
(86) PCT No.: PCT/IL2022/051088

§ 371 Date: Apr. 15, 2024

Related U.S. Application Data
(60) Provisional application No. 63/255,456, filed on Oct. 14, 2021.
(60) Provisional application No. 63/294,476, filed on Dec. 29, 2021.

(51) Int. Cl. A01N 43/56; A01N 35/06; A01N 35/10; A01N 37/10; A01N 65/08; A01P 13/02

(52) U.S. Cl. CPC A01N 43/56; A01N 35/06; A01N 35/10; A01N 37/10; A01N 65/08; A01P 13/02

(57) ABSTRACT

A method of weed control is provided. The method comprising applying an effective amount of an ACCase inhibitor to a weed species of interest of Broadleaf weeds.

### RELATED APPLICATIONS

This application claims priority from U.S. Patent Application No. 63/255,456 filed on 14 Oct. 2021 and U.S. Patent Application No. 63/294,476 filed on 29 Dec. 2021, each of which is incorporated by reference in its entirety.

### FIELD AND BACKGROUND OF THE INVENTION

The present invention, in some embodiments thereof, relates to methods of inhibiting growth of weeds.

Weeds have been the major biotic cause of crop yield loses since the origins of agriculture. The potential of weed damages is estimated as 34% loss of crop yield, on average, world-wide [Oerke, E-C., 2006]. In the USA alone, the annual cost of crop losses due to weeds is greater than 26 billion USD [Pimentel D et al., 2000]. Furthermore according to the Weed Science Society of America Weeds are estimated to cause more than 40 billion USD in annual global losses [wssa(dot)net/wssa/weed/biological-control/]. Weeds are thus a major threat to food security [Delye et al., 2013].

Herbicides are the most commonly used and effective weed control tools. Due to the intense selection pressure exerted by herbicides, herbicide resistance is constantly growing and as of 2016 there are over 470 weed biotypes currently identified as being herbicide resistant to one or more herbicides by The International Survey of Herbicide Resistant Weeds (weedscience(dot)org/).

Acetyl-CoA carboxylase (ACCase), EC 6.4.1.2, catalyses the ATP-dependent carboxylation of acetyl-CoA to malonyl-CoA in a multistep reaction. This is the first committed step in fatty acid synthesis, is rate-limiting for the pathway, and is tightly regulated. ACCase inhibitors are primarily used for postemergence grass control in broadleaf crops. These herbicides are absorbed through the foliage and translocated in the phloem to the growing point, where they inhibit meristematic activity. ACCase Inhibitors include herbicides belonging to Aryloxyphenoxypropionate (FOPs), cyclohexanedione (DIMs), and phenylpyrazolin (DENs) chemistries. These herbicides inhibit the enzyme acetyl-CoA carboxylase (ACCase), which catalyzes the first step in fatty acid synthesis and is important for membrane synthesis. In general, broadleaf species are naturally resistant to FOPs, DIMs, and DENs herbicides because of a less sensitive ACCase enzyme (Dorr, in Comprehensive Medicinal Chemistry II, 2007). This underpins their success as nontoxic and selective grassweed killers, and highlights ACCase as having scope for selective inhibition with a lethal effect on the target species.
www3(dot)epa(dot)gov/pesticides/chem_search/ppls/092647-00031-20210616(dot)pdf

Additional related background Art:
PCT Publication No. WO2017/203519;
PCT Publication No. WO2019/106667;
PCT Publication No. WO2019/106666;
PCT Publication No. WO2019/106668;
PCT Publication No. WO2019/215581;
PCT Publication No. WO2019/215582;
PCT Publication No. WO2020/084586;
Siddiqui and Al-Rumman Caryologia. International Journal of Cytology, Cytosystematics and Cytogenetics 73(1): 37-44, 2020;
pat(dot)unl(dot)edu/Poster%20Andrea%20final(dot)pdf;
Seale et al, Agronomy 2020, 10, 1058; doi:10.3390/agronomy10081058.

### SUMMARY OF THE INVENTION

According to an aspect of some embodiments of the present invention there is provided a method of weed control, the method comprising applying an effective amount of an Acetyl-CoA Carboxylase (ACCase) inhibitor to a broadleaf weed species of interest, wherein the applying is at a time window restricted to flowering.

According to an aspect of some embodiments of the present invention there is provided a method of weed control, the method comprising applying an effective amount of an Acetyl-CoA Carboxylase (ACCase) inhibitor to a weed species of interest of the Amaranthus genus, wherein the applying is at a time window restricted to flowering.

According to an aspect of some embodiments of the present invention there is provided a method of weed control, the method comprising applying an effective amount of an Acetyl-CoA Carboxylase (ACCase) inhibitor to a broadleaf weed species of interest, wherein the effective amount is below or above Gold standard or an amount authorized by a regulatory agency.

According to an aspect of some embodiments of the present invention there is provided a method of weed control, the method comprising applying an effective amount of an Acetyl-CoA Carboxylase (ACCase) inhibitor to a weed species of interest of the Amaranthus genus, wherein the effective amount is below or above Gold standard or an amount authorized by a regulatory agency.

According to some embodiments of the invention, the applying is at a time window restricted to flowering.

According to some embodiments of the invention, the applying is at a time window wherein the weed species of interest is devoid of seeds.

According to some embodiments of the invention, the effective amount is below Gold standard or an amount authorized by a regulatory agency.

According to some embodiments of the invention, a predominant amount of at least 20% of plants of the weed species of interest in a growth area are at the time window at the applying.

According to some embodiments of the invention, the weed species is A. palmeri and/or A. tuberculatus.

According to some embodiments of the invention, the broadleaf weed species of interest is selected from the group consisting of Amaranthus species—A. albus, A. blitoides, A. hybridus, A. palmeri, A. powellii, A. retroflexus, A. rudis, A. spinosus, A. tuberculatus, and A. viridis; Ambrosia species—A. trifida, A. artemisifolia; Euphorbia species—E. heterophylla; Kochia species—K. scoparia; Conyza species—C. bonariensis, C. canadensis, C. sumatrensis; Plantago species—P. lanceolata, Chenopodium species—C. album; Abutilon theophrasti, Ipomoea species, Sesbania, species, Cassia species, Sida species and Solanum species.

According to some embodiments of the invention, the broadleaf weed species of interest is selected from the group consisting of Amaranthus palmeri, Amaranthus tuberculatus, Solanum nigrum, Abutilon theophrasti and Conyza bonariensis.

According to some embodiments of the invention, the weed control is effected at a growth area of at least an acre and optionally not exceeding 50,000 acres.

According to some embodiments of the invention, the ACCase inhibitor is selected from the group consisting of Cyclohexanedione (DIM), Aryloxyphenoxypropionate (FOP) and Phenylpyrazolin (DEN).

According to some embodiments of the invention, the ACCase inhibitor is clethodim.

According to some embodiments of the invention, the ACCase inhibitor is clethodim and the effective amount is 0.05-5 g/liter.

According to some embodiments of the invention, the ACCase inhibitor is clethodim is Select Super™ or Arrow Super™.

According to some embodiments of the invention, the applying is effected when an amount of said weed species of interest is above 40 plants/acre.

According to some embodiments of the invention, the applying is effected in a growth area comprising crop.

According to some embodiments of the invention, the crop is modified to comprise an ACCase inhibition resistance.

According to some embodiments of the invention, the method further comprises artificially pollinating the weed species of interest with pollen of the same species that reduces fitness of the weed species of interest.

According to some embodiments of the invention, the applying the ACCase inhibitor is effected prior to the artificially pollinating.

According to some embodiments of the invention, the applying is effected 3-14 days prior to the artificially pollinating (e.g., 3-7 d, 3-10 d, 3-14 d, 7-14 d, 7-10 d).

According to some embodiments of the invention, the applying the ACCase inhibitor is effected concomitantly with the artificially pollinating.

According to some embodiments of the invention, the ACCase inhibitor and pollen for the artificially pollinating are in a co-formulation.

According to some embodiments of the invention, the ACCase inhibitor and pollen for the artificially pollinating are in separate formulations.

According to some embodiments of the invention, the applying the ACCase inhibitor is effected prior to and concomitantly with the artificially pollinating.

According to some embodiments of the invention, a regimen for the applying comprises applying the ACCase inhibitor at least once is effected (e.g., up to 14 days) prior to the artificially pollinating followed by concomitant treatment with the ACCase inhibitor and the artificially pollinating and optionally followed by artificially pollinating with or without the applying the ACCase inhibitor.

According to some embodiments of the invention, the applying is on male plant and not on female.

According to some embodiments of the invention, the applying is on female weed plant and not on male.

According to some embodiments of the invention, the applying is on male and female flowers or hermaphrodites.

According to some embodiments of the invention, crop environment of the weed species is selected from the group consisting of soybean, potato, corn, peanut, cotton, tomato, sunflower and pea.

According to some embodiments of the invention, crop environment of the weed species is selected from the group consisting of soybean, potato, corn, peanut, cotton, tomato and sunflower.

According to some embodiments of the invention, the pollen is non-genetically modified pollen.

According to some embodiments of the invention, the non-genetically modified pollen is irradiated pollen.

According to some embodiments of the invention, the non-genetically modified pollen is irradiated pollen with x-ray or gamma ray.

According to some embodiments of the invention, the pollen having been treated with a sterilant.

According to some embodiments of the invention, the pollen is genetically modified pollen.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a graph showing collected pollen weight of Paraffin:Silicon oil, Clethodim, H₂O and blank groups by days before and after treatment. Both Paraffin:Silicon and Clethodim reduced the pollen weight by the 5^{th} day after treatment, an effect that lasted for 14 days under the practiced conditions.

FIG. 2 is a graph showing collected pollen weight of the Clethodim treatment group. From 5-8 DAT a major reduction in pollen weight is visible, with an onset of pollen production 13 DAT under the practiced conditions.

FIG. 3 is a graph showing collected pollen weight of pure Silicon oil 2 cST, 2% Paraffin oil in silicon oil and blank groups by days before and after treatment. Both Silicon oil and 2% Paraffin oil did not reduce the pollen weight under the practiced conditions compared to the blank.

FIG. 4 is a graph showing collected pollen weight of 10% Paraffin oil in Silicon oil, Clethodim and blank groups by days before and after treatment. Both treatments reduced the pollen weight for 8 days, with Clethodim having a major reduction of up to 80% less than the blank pollen weight under the practiced conditions.

FIG. 5 is a graph showing total seeds collected from inflorescences by days after treatment. The numbers are average of 4 or 6 inflorescences from 2 or 3 plants, respectively.

FIG. 6 is a graph showing the average abortion rate (aborted seeds/total seeds) by days after treatment. The numbers are average of 4 or 6 inflorescences from 2 or 3 plants, respectively.

FIG. 7 is a graph showing time dependent average total seed collected per spike. The numbers are average of 6 spikes from 3 plants. Both clethodim treatments reduced the number of seed produced, the reduction is stronger in the high dose.

FIG. 8 is a box plot graph showing total seed when all time points are averaged together. The numbers are average of 6 spikes from 3 plants.

FIG. 9 is a box plot graph showing the average abortion rate (i.e. number of aborted seeds/total number of seeds) when all time points are averaged together.

FIG. 10 is a graph showing the average of total number of seeds collected per spike by days after treatment. The numbers are an average of 4 spikes from 4 plants. Both commercial formulations of clethodim treatments showed strong reduction in seed formation.

FIG. 11 is a graph showing the average of total number of seeds collected per spike by days after treatment. The numbers are an average of 4 spikes from 4 plants. Clear reduction in seed number was obtained following the applications of all the tested active ingredients.

FIG. 12 is a graph showing the average of total seed weight collected per spike by days after treatment. The numbers are an average of 6 spikes from 3 plants.

FIG. 13 is a graph showing collected pollen weight following application of two clethodim based product: Clethodim (Select Super™ in low and high rate and Clethodim (Arrow Super™ in high rate, by days after treatment). The pollen was collected from 10 male plants for each treatment. All three clethodim applications caused a serious reduction in pollen production.

FIG. 14 is a graph showing the average stem length and the average pods number per plant 15 days after application of clethodim [Select Super™].

FIG. 15 is a graph showing the average total fruits number per plant 15 days after application of clethodim [Select Super™].

FIG. 16 is a graph showing the average number of fertile flowers per plant, 15 days after application of clethodim [Select Super™].

FIG. 17 presents two representative photos of clethodim treated (right side) and control non-treated (left side) Abutilon theophrasti plants.

FIG. 18 presents two representative photos of clethodim treated (right side) and control non-treated (left side) Amaranthus tuberculatus male plants.

FIG. 19 presents two representative photos of clethodim treated (right side) and control non-treated (left side) Solanum Nigrum plants.

FIG. 20 presents two representative photos of clethodim treated (right side) and control non-treated (left side) Conyza bonariensis plants.

FIG. 21 is a graph showing the average of normal number of seeds collected per spike, 40 days after planting with different application timings of clethodim at various A. palmer growth stages. The numbers represent an average of 8 spikes from 8 plants.

### DESCRIPTION OF SPECIFIC EMBODIMENTS OF THE INVENTION

The present invention, in some embodiments thereof, relates to methods of inhibiting growth of weeds.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

Weeds are plants that are unwanted in any particular environment. They compete with cultivated plants in an agronomic environment and also serve as hosts for crop diseases and insect pests. The losses caused by weeds in agricultural production environments include decreases in crop yield, reduced crop quality, increased irrigation costs, increased harvesting costs, reduced land value, injury to livestock, and crop damage from insects and diseases harbored by the weeds.

While conceiving embodiments of the invention and reducing them to practice, the present inventors have realized that acetyl CoA carboxylase (ACCase) inhibitors can be used beneficially for controlling broadleaf weeds such as of the genus Amaranthus when provided at the flowering stage since they affect the sexual organs of the weed.

Without being bound by theory, the present findings may be explained as follows. Two forms of Accase, have been found in dicotyledonous plants: the prokaryotic and the eukaryotic forms (1-4). The prokaryotic ACCase is composed of several subunits, one of which is encoded in plastid genome and named accD, and exists in plastids. The eukaryotic ACCase is composed of a single multi-functional polypeptide and exists in cytosol.

Graminae use only the eukaryotic (cytosolic) form of ACCase and are inhibited by clethodim and other ACCase inhibitors.

Dicot plants, in the sporophytic stages of growth, use the prokaryotic (plastid) form of ACCase for lipid biosynthesis in their plastids throughout the plants and are thus resistant to the effects of ACCase inhibitors. Thus, application of these inhibitors would not cause a lethal effect on dicots in stark contrast to monocots/grasses in which such an application is detrimental.

Therefore, a material that is usually used for the control of grass weeds and is not expected to affect broadleaf weeds surprisingly affects them as exemplified on various species.

These findings pave the way to any Broadleaf weed control using ACCase inhibitors. Since the present teachings reduce seed set it actually controls any broadleaf weed seed bank.

Thus, according to an aspect of the invention there is provided a method of weed control, the method comprising applying an effective amount of an Acetyl-CoA Carboxylase (ACCase) inhibitor to a broadleaf weed species of interest, wherein said applying is at a time window restricted to flowering.

Alternatively or additionally, there is provided a method of weed control, the method comprising applying an effective amount of an Acetyl-CoA Carboxylase (ACCase) inhibitor to a weed species of interest of the Amaranthus genus, wherein said applying is at a time window restricted to flowering.

Alternatively or additionally, there is provided a method of weed control, the method comprising applying an effective amount of an Acetyl-CoA Carboxylase (ACCase) inhibitor to a broadleaf weed species of interest, wherein said effective amount is below or above Gold standard or an amount authorized by a regulatory agency.

Alternatively or additionally, there is provided a method of weed control, the method comprising applying an effective amount of an Acetyl-CoA Carboxylase (ACCase) inhibitor to a weed species of interest of the Amaranthus genus, wherein said effective amount is below or above Gold standard or an amount authorized by a regulatory agency.

As used herein “weed control” refers to suppressing growth and optionally spread of a population of at least one broadleaf weed species of interest and even reducing the size of the population in a given growth area. According to a specific embodiment, the effect of the ACCase inhibitor in weed control is manifested at F₁ and not at F₀ since it affects reproduction. However, phenotypic changes are present at F₀, e.g., changes in pollen and/or stigma that lead to the weed control effect at F₁.

According to a specific embodiment, the growth area is at least one acre and optionally not exceeding 50,000 acres. According to a specific embodiment, the size is 0.5-10000 acres, e.g., 1-10000, 10-10000, 100-10000 acres.

According to a specific embodiment, the growth area is an urban area, e.g., golf courses, athletic fields, parks, cemeteries, roadsides, home gardens/lawns and the like.

According to an additional or alternative embodiment, the growth area is a rural area.

According to an additional or an alternative embodiment, the growth area is an agricultural growth area e.g., open field, greenhouse, plantation, vineyard, orchard and the like.

According to a specific embodiment, controlling weed is contemplated in a crop growth area.

As used herein “crop” refers to a plant that can be grown and harvested for profit or subsistence. By use, crops fall into six categories: food crops, feed crops, fiber crops, oil crops, ornamental crops, and industrial crops. According to specific embodiments of the invention, the crop plant is typically resistant to ACCase inhibitors. According to a specific embodiment, the crop has an acquired resistance to ACCase inhibitors such as by way of man-made genetic manipulation or a natural mutation. Systems for acquiring resistance are described hereinbelow according to some embodiments of the invention.

Thus, crop plants include floral and non-floral plants, trees, vegetable plants, turf, and ground cover.

Non-limiting specific examples of crop plants include canola, flax, peas, lentils, beans, linola, mustard, chickpeas, sunflowers, potatoes, seedling alfalfa, onions, soybeans, sugarbeet and turf grass.

According to a specific embodiment, the crop plant is a dicotyledonous plant.

According to a specific embodiment, the crop plant is a monocotyledonous plant.

According to a specific embodiment, the crop is selected from the group consisting of soybean, potato, corn, peanut, cotton, tomato, sunflower and pea.

According to a specific embodiment, the crop is selected from the group consisting of soybean, potato, corn, peanut, cotton, tomato, sunflower.

As used herein “crop environment” relates to crop which grows in vicinity to the weed, e.g., on the same growth area, e.g., plot.

According to a specific embodiment, the crop plant exhibits natural resistance to ACCase inhibitors. Such crop plants are typically dicots, which as explained above, exhibit resistance of ACCase inhibition.

As mentioned, according to another embodiment, the crop plant is modified such as genetically modified to exhibit resistance to ACCase inhibition. Such modifications, either man-made or naturally occurring, can render a sensitive monocot plant resistant to ACCase inhibition.

Thus a crop plant according to the present teachings can be any plant such as corn, rice wheat.

According to another embodiment, the crop is modified to comprise an ACCase inhibition resistance. This can be by chemical or genetic intervention. One such a system is that of the Enlist weed control system which provides FOP (described in details below) resistance, where the introduced enzyme degrades the herbicide.

Other systems are also known in the art, such as in US20170275645 describing a mutagenized rice acetyl-Coenzyme A carboxylase (ACCase) nucleic acid having a sequence such as obtained by an induced, random mutagenesis method and encoding a rice plastidic ACCase having, as a result of said mutagenesis, a tryptophan-to-cysteine substitution at the amino acid position corresponding to position 2,027 of the Alopecurus myosuroides (Am) plastidic ACCase, said rice plastidic ACCase conferring to the rice plant increased tolerance to an ACCase inhibiting herbicide as compared to that of a corresponding wild-type rice plant.

US 20140377835 teaches various mutations in monocotyledonous plants which impart resistance to ACCase inhibition.

Other systems are described in EP2473024, US20220135993, U.S. Pat. No. 5,498,544A, US20210153448, EP0919119, WO2011028832, TW201113376A and in Raven Bough et al., Sci Rep 12, 2022 Biochemical and structural characterization of quizalofop-resistant wheat acetyl-CoA carboxylase, Raven Bough et al., Sci Rep 12, 2022, each of which is incorporated herein by reference in its entirety.

As used herein “Acetyl-CoA Carboxylase”, abbreviated as ACCase, EC 6.4.1.2, is an enzyme that consists of three functional domains: biotin-carboxyl carrier protein (BCCP), biotin carboxylase (BC), and carboxyltransferase (CT, with subunits α and β). The BC and CT domains shoulder the catalytic activities that are dependent upon ATP, Mg², and HCO₃⁻, which result in acetyl-CoA carboxylation and the formation of malonyl-CoA. While malonyl-CoA is necessary for de novo synthesis of fatty acids in plastids, cytosolic malonyl-CoA is required for the elongation of very long chain fatty acids (VLCFAs) and secondary metabolites such as flavonoids and suberins). Plants express plastidic and cytoplasmic ACCase isoforms. The plastidic isoform is responsible for more than 80% of total ACCase activity in leaves. Plants belonging to the Poaceae family (grasses), have a homomeric (or eukaryotic) plastidic ACCase in which the BCCP, BC, and CT domains are localized within a single polypeptide chain. Both plastidic and cytoplasmic ACCase in Poaceae become active when homodimerized. Dicotyledonous plants have homomeric form in the cytoplasm and heteromeric (or prokaryotic) form in the plastids, where each domain is encoded by different genes expressed in a coordinated fashion.

As used herein “inhibitor” refers to a substance which decreases the expression or activity of ACCase in broadleaf weeds.

As used herein “decreases” or “decreasing” or any grammatical deviation thereof refers to at least 20%, 30%, 40%, 50%, 60%, 70%, 80%, 90% or even complete (100%) reduction in the expression or activity of ACCase, as compared to a control plant not having been treated with the inhibitor, yet otherwise being of the same developmental stage and growth conditions.

According to a specific embodiment, the substance is a small molecule.

ACCase-inhibiting herbicides are typically divided into three chemical families: aryloxyphenoxypropionates (FOPs), cyclohexanodiones (DIMs), and phenylpyrazole (DENs). All molecules belonging to these chemical groups consist of a carbon skeleton with polar substituents, but structures presenting distinct characteristics. Most FOPs are in the form of formulated methyl, butyl or ester, providing more lipophilicity and increased capacity to cross cellular membranes by acid trapping. These herbicides have a molecular weight of between 327 and 400 g mol¹, pKa of 3.5-4.1 in their weak acid form and Log K ow of 3.6-4.2 in the formulated form.

The three classes of ACCase-inhibiting herbicides have limited residual activity in the soil. This is attributed to their high values of solid-liquid partition (K_{d}) and adsorption potential (K_{oc}), resulting in herbicide molecules becoming tightly bound to soil particles. However, once in the soil, these herbicides can be converted to their acid form, and be absorbed by plant roots. The potential for carryover varies from one species to another, soil characteristics, and herbicide dosage, but residual activity was not observed for more than 14 days.

It is expected that during the life of a patent maturing from this application many relevant ACCase inhibitors will be developed and the scope of the term is intended to include all such new technologies a priori.

For the present invention, the terms “herbicide-tolerant” and “herbicide-resistant” are used interchangeably and are intended to have an equivalent meaning and an equivalent scope. Similarly, the terms “herbicide-tolerance” and “herbicide-resistance” are used interchangeably and are intended to have an equivalent meaning and an equivalent scope. Similarly, the terms “tolerant” and “resistant” are used interchangeably and are intended to have an equivalent meaning and an equivalent scope.

Table 1A provides a list of cyclohexanedione herbicides (DbIs, also referred to as: cyclohexene oxime cyclohexanedione oxime; and CHD) that interfere with acetyl-Coenzyme A carboxylase activity and may be used in accordance with the present teachings. One skilled in the art will recognize that other herbicides in this class exist and may be used in accordance with the present teachings. Also included in Table HA is a list of aryloxyphenoxy propionate herbicides (also referred to as aryloxyphenoxy propanoate; aryloxyphenoxyalkanoate; oxyphenoxy; APP; AOPP; APA; APPA; FOP, note that these are sometime written with the suffix ‘-oic’) that interfere with acetyl-Coenzyme A carboxylase activity and may be used in accordance with the present teachings. One skilled in the art will recognize that other herbicides in this class exist and may be used in conjunction with the herbicide-tolerant plants of the invention.

Also included in Table 1A is, ACCase-inhibiting herbicides of the phenylpyrazole class, also known as DENs, which can be used as well. An exemplary DEN is pinoxaden, which is a phenylpyrazoline-type member of this class. Herbicide compositions containing pinoxaden are sold under the brands Axial and Traxos. Also contemplated are salts, esters and other derivatives of the ACCase inhibitors.

TABLE 1A

| Selective | | Examples for materials |
|---|---|---|
| herbicides | General | belonging to the section |
| ACCase inhibitors | Cyclohexanediones (DIMs), | Clethodim, tepraloxydim, Sethoxydim, |
| | | Cycloxydim, Tralkoxydim, Alloxydim, |
| | | Butroxydim, Cloproxydim, Profoxydim, |
| | Aryloxyphenoxypropionates | haloxyfop, Fluazifop Metamifop, |
| | (FOPs), | Haloxyfop, Fenoxaprop, Quizalofop, |
| | Phenylpyrazolin (DEN) | Clodinafop, Diclofop, Clofop, |
| | | Cyhalofop, Fenthiaprop, Fluazifop, |
| | | Isoxapyrifop, Metamifop, |
| | | Propaquizafop, |
| | | Pinoxaden |

Table 1B below provides a number of ACCase inhibitors, suggested vendors and recommended rates, each of which is considered a separate embodiment.

TABLE 1B

| | | | Example | Maximum | |
|---|---|---|---|---|---|
| ACCase | | | Trade | Rate | |
| Inhibitor | Class | Company | Names | [g al/ha] | Use |
| alloxydim | DIM | BASF | Fervin, Kusagard, | 1000 | POST |
| | | | NP, 48Na, | | |
| | | | BAS 9021H | | |
| butroxydim | DIM | Syngenta | Falcon, ICI-A0500 | 75 | POST |
| clethodim | DIM | Valent | Select, Prism, | 280 | POST |
| | | | RE-45601 | | |
| clodinafop- | FOP | Syngenta | Discover, Topik, | 80 | POST |
| propargyl | | | CGA 184 927 | | |
| cycloxydim | DIM | BASF | Focus, Laser, | 448 | POST |
| | | | Stratos, BAS 517H | | |
| cyhalofop- | FOP | Dow | Clincher, XDE 537, | 310 | POST |
| butyl | | | DEH 112 | | |
| diclofop- | FOP | Bayer | Hoegrass, Hoelon, | 1120 | POST |
| methyl | | | liloxan, HOE 23408 | | |
| fenoxaprop- | FOP | Bayer | Super Whip, Option | 111 | POST |
| P-ethyl | | | Super, Exel Super, | | |
| | | | HOE-46360, Aclaim, | | |
| | | | Puma S | | |
| fluazifop-P- | FOP | Syngenta | Fusilade, Fusilade | 210 | POST |
| butyl | | | 2000, Fusilade DX, | | |
| | | | ICI-A0009, | | |
| | | | ICI-A0005, SL-236, | | |
| | | | IH-773B, TF-1169 | | |
| haloxyfop- | FOP | Dow | Gallant, DOWCO | 600 | POST |
| etotyl | | | 453EE | | |
| haloxyfop- | FOP | Dow | Verdict, DOWCO | 600 | POST |
| methyl | | | 453ME | | |
| haloxyfop- | FOP | Dow | Edge, DE 535 | 600 | POST |
| P-methyl | | | | | |
| metamifop | FOP | Donghu | NA | 201 | POST |
| pinoxaden | DEN | Syngenta | Axial | 50 | POST |
| proloxydim | DIM | BASF | Aura, Tetris, | 212 | POST |
| | | | BAS 625H | | |
| propaquizafop | FOP | Syngenta | Agil, Shogun, | 150 | POST |
| | | | Ro 17-3664 | | |
| quizalofop-P- | FOP | DuPont | Assure, Assure II, | 112 | POST |
| ethyl | | | DPX-Y6202-3, | | |
| | | | Targa Super, NC-302 | | |
| quizalofop-P- | FOP | Uniroyal | Pantera, UBI C4874 | 112 | POST |
| tefuryl | | | | | |
| sehtoxydim | DIM | BASF | Poast, Poast Plus, | 560 | POST |
| | | | NABU, Fervinal, | | |
| | | | NP-55, Sertin, | | |
| | | | BAS 562H | | |
| tepraloxydim | DIM | BASF | BAS 520H, Aramo | 50 | POST |
| tralkoxydim | DIM | Syngenta | Achieve, Splendor, | 3400 | POST |
| | | | ICI-A0604 | | |

The vendor should not in any way be limited to those described here as many more are available e.g., AMVAC.

According to a specific embodiment, the ACCase inhibitor is of the DIMs group.

According to a specific embodiment, the ACCase inhibitor is clethodim. Numerous formulations of clethodim are commercially available. For example, clethodim is provided by Valent U.S.A. Corporation and Arysta LifeScience North America, Sethoxydim and Alloxydim are produced by Nippon Soda Company or BASF Corporation, Cycloxydim and Profoxydim are produced by BASF Corporation, and Butroxydim is produced by CropCare Australia.

WO2016196130 2015-06-042016-12-08 to Arysta Lifescience North America, LlcSurfactant-stabilized cyclohexanedioxide oxime formulations; and WO2020053763 2018-09-142020-03-19 to Adama Agan Ltd. Stabilized cyclohexanedione oxime composition, relate to stabilized formulations of cyclohexanedione (e.g., clethodim). The Examples section below relates to clethodim available from Arysta Lifescience, Adama Agan Ltd. and Syngenta Other formulations and vendors include, but are not limited to those available from Valent USA L.L.C (sold in the U.S. under the brand name of Select Max® and Select® 2EC-), UPL Ltd. (sold in the U.S. under the brand name of Shadow®, Shadow® 3EC, Trizenta®, Trizenta® 3EC), Tide (sold in the U.S. under the brand name of Tide clethodim 2EC™) and Willowood Chemicals Ltd (sold in the U.S. under the brand name of Clethodim 2EC™).

According to a specific embodiment, the clethodim is provided at an effective amount of 0.05-5 g/liter, 0.05-4 g/liter, 0.05-3 g/liter, 0.05-2 g/liter, 0.05-1 g/liter, 0.01-5 g/liter, 0.1-5 g/liter, 0.5-5 g/liter, 1-5 g/liter.

According to a specific embodiment, the inhibitor is a nucleic acid molecule.

Below is a description of platform technologies for effecting knock-out (also referred to as “genome editing”) and transcriptional silencing in plants.

Methods of introducing nucleic acid alterations to a gene of interest (in this case ACCase) are well known in the art [see for example Menke D. Genesis (2013) 51: -618; Capecchi, Science (1989) 244:1288-1292; Santiago et al. Proc Natl Acad Sci USA (2008) 105:5809-5814; International Patent Application Nos. WO 2014085593, WO 2009071334 and WO 2011146121; U.S. Pat. Nos. 8,771,945, 8,586,526, 6,774,279 and UP Patent Application Publication Nos. 20030232410, 20050026157, US20060014264; the contents of which are incorporated by reference in their entireties] and include targeted homologous recombination, site specific recombinases, PB transposases and genome editing by engineered nucleases. Agents for introducing nucleic acid alterations to a gene of interest can be designed using publicly available sources or obtained commercially from Transposagen, Addgene and Sangamo Biosciences.

Following is a description of various exemplary methods used to introduce nucleic acid alterations to a gene of interest and agents for implementing same that can be used according to specific embodiments of the present invention.

Any of the below methods can be directed to any part of the ACCase gene as long as a loss-of-function is achieved.

Silencing at the ACCase transcript (RNA) level can be effected using the below exemplary platforms.

As used herein, the phrase “RNA silencing” refers to a group of regulatory mechanisms [e.g. RNA interference (RNAi), transcriptional gene silencing (TGS), post-transcriptional gene silencing (PTGS), quelling, co-suppression, and translational repression] mediated by RNA molecules which result in the inhibition or “silencing” of the expression of a corresponding protein-coding gene. RNA silencing has been observed in many types of organisms, including plants, animals, and fungi.

As used herein, the term “RNA silencing agent” refers to an RNA which is capable of specifically inhibiting or “silencing” the expression of a target gene (ACCase). In certain embodiments, the RNA silencing agent is capable of preventing complete processing (e.g., the full translation and/or expression) of an mRNA molecule through a post-transcriptional silencing mechanism. RNA silencing agents include non-coding RNA molecules, for example RNA duplexes comprising paired strands, as well as precursor RNAs from which such small non-coding RNAs can be generated. Exemplary RNA silencing agents include dsRNAs such as siRNAs, miRNAs and shRNAs.

In one embodiment, the RNA silencing agent is capable of inducing RNA interference.

In another embodiment, the RNA silencing agent is capable of mediating translational repression.

According to an embodiment of the invention, the RNA silencing agent is specific to the target RNA and does not cross inhibit or silence other targets or a splice variant which exhibits 99% or less global homology to the target gene, e.g., less than 98%, 97%, 96%, 95%, 94%, 93%, 92%, 91%, 90%, 89%, 88%, 87%, 86%, 85%, 84%, 83%, 82%, 81% global homology to the target gene; as determined by PCR, Western blot, Immunohistochemistry and/or flow cytometry.

RNA interference refers to the process of sequence-specific post-transcriptional gene silencing in animals mediated by short interfering RNAs (siRNAs).

Following is a detailed description on RNA silencing agents that can be used according to specific embodiments of the present invention.

DsRNA, siRNA and shRNA—The presence of long dsRNAs in cells stimulates the activity of a ribonuclease III enzyme referred to as dicer. Dicer is involved in the processing of the dsRNA into short pieces of dsRNA known as short interfering RNAs (siRNAs). Short interfering RNAs derived from dicer activity are typically about 21 to about 23 nucleotides in length and comprise about 19 base pair duplexes. The RNAi response also features an endonuclease complex, commonly referred to as an RNA-induced silencing complex (RISC), which mediates cleavage of single-stranded RNA having sequence complementary to the antisense strand of the siRNA duplex. Cleavage of the target RNA takes place in the middle of the region complementary to the antisense strand of the siRNA duplex.

Accordingly, some embodiments of the invention contemplate use of dsRNA to downregulate protein expression from mRNA.

According to one embodiment dsRNA longer than 30 bp are used. Various studies demonstrate that long dsRNAs can be used to silence gene expression without inducing the stress response or causing significant off-target effects—see for example [Strat et al., Nucleic Acids Research, 2006, Vol. 34, No. 13 3803-3810; Bhargava A et al. Brain Res. Protoc. 2004; 13:115-125; Diallo M., et al., Oligonucleotides. 2003; 13:381-392; Paddison P. J., et al., Proc. Natl Acad. Sci. USA. 2002; 99:1443-1448; Tran N., et al., FEBS Lett. 2004; 573:127-134].

According to some embodiments of the invention, dsRNA is provided in cells where the interferon pathway is not activated, see for example Billy et al., PNAS 2001, Vol 98, pages 14428-14433. and Diallo et al, Oligonucleotides, Oct. 1, 2003, 13(5): 381-392. doi:10.1089/154545703322617069.

According to an embodiment of the invention, the long dsRNA are specifically designed not to induce the interferon and PKR pathways for down-regulating gene expression. For example, Shinagwa and Ishii [Genes & Dev. 17 (11): 1340-1345, 2003] have developed a vector, named pDECAP, to express long double-strand RNA from an RNA polymerase II (Pol II) promoter. Because the transcripts from pDECAP lack both the 5′-cap structure and the 3′-poly(A) tail that facilitate ds-RNA export to the cytoplasm, long ds-RNA from pDECAP does not induce the interferon response.

Another method of evading the interferon and PKR pathways in mammalian systems is by introduction of small inhibitory RNAs (siRNAs) either via transfection or endogenous expression.

The term “siRNA” refers to small inhibitory RNA duplexes (generally between 18-30 base pairs) that induce the RNA interference (RNAi) pathway. Typically, siRNAs are chemically synthesized as 21mers with a central 19 bp duplex region and symmetric 2-base 3′-overhangs on the termini, although it has been recently described that chemically synthesized RNA duplexes of 25-30 base length can have as much as a 100-fold increase in potency compared with 21mers at the same location. The observed increased potency obtained using longer RNAs in triggering RNAi is suggested to result from providing Dicer with a substrate (27mer) instead of a product (21mer) and that this improves the rate or efficiency of entry of the siRNA duplex into RISC.

It has been found that position of the 3′-overhang influences potency of a siRNA and asymmetric duplexes having a 3′-overhang on the antisense strand are generally more potent than those with the 3′-overhang on the sense strand (Rose et al., 2005). This can be attributed to asymmetrical strand loading into RISC, as the opposite efficacy patterns are observed when targeting the antisense transcript.

The strands of a double-stranded interfering RNA (e.g., an siRNA) may be connected to form a hairpin or stem-loop structure (e.g., an shRNA). Thus, as mentioned, the RNA silencing agent of some embodiments of the invention may also be a short hairpin RNA (shRNA).

The term “shRNA”, as used herein, refers to an RNA agent having a stem-loop structure, comprising a first and second region of complementary sequence, the degree of complementarity and orientation of the regions being sufficient such that base pairing occurs between the regions, the first and second regions being joined by a loop region, the loop resulting from a lack of base pairing between nucleotides (or nucleotide analogs) within the loop region. The number of nucleotides in the loop is a number between and including 3 to 23, or 5 to 15, or 7 to 13, or 4 to 9, or 9 to 11. Some of the nucleotides in the loop can be involved in base-pair interactions with other nucleotides in the loop. Examples of oligonucleotide sequences that can be used to form the loop include 5′-CAAGAGA-3′ and 5′-UUACAA-3′ (International Patent Application Nos. WO2013126963 and WO2014107763). It will be recognized by one of skill in the art that the resulting single chain oligonucleotide forms a stem-loop or hairpin structure comprising a double-stranded region capable of interacting with the RNAi machinery.

Zabala-Pardo et al, Adv Weed Sci. 2022; 40(Spec1):e020220096 teaches the use of RNAi as herbicides while relating also to ACCase inhibition. Bandaranayake and Yoder MPMI Vol. 26, No. 5, 2013, pp. 575-584. dx(dot)doi(dot)org/10(dot)1094/MPMI-12-12-0297-R. teach RNAi for ACCase inhibition.

Thus, any formulation (also referred to as “composition”) of the above ACCase inhibitors is contemplated herein. These compositions comprise an effective amount of at least one of the ACCase inhibitors and potentially other herbicides and/or safeners, adjuvants and auxiliaries which are customary for the formulation of crop protection agents. Thus, the formulation may include one or more inhibitors for ACCases and optionally herbicides for any weed control e.g., broadleaf weeds, but not necessarily.

The composition may include one or more adjuvants. An adjuvant may enhance or improve weed control performance, for example. Adjuvants may be added to the composition at the time of formulation, or by the applicator to a mix prior to treatment. Adjuvants include, for example, surfactants (emulsifier), crop oil, stickers, fertilizers, dispersing agents, compatibility agents, foaming activators, foam suppressants, correctives, bactericides and spray colorants (dyes). An adjuvant may be present in any desired amount. For example, a formulation may contain 0.1% to 3% adjuvant, 3% to 8% of adjuvant, 8% to 16% adjuvant, 17% to 30% adjuvant, or 30% or (e.g. 40% or more) more adjuvant.

Bactericides can be added for stabilizing aqueous formulations. Examples of bactericides are bactericides based on diclorophen and benzy alcohol hemiformal (Proxel® from ICI or Acticide® RS from Thor Chemie and Kathon® MK from Rohm & Haas), and also isothiazolinone derivates, such as alkylisothiazolinones and benzisothiazolinones (Acticide MBS from Thor Chemie).

Examples of colorants are both sparingly water-soluble pigments and water-soluble dyes. Examples which may be mentioned are the dyes known under the names Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers-types, Borregaard), phenolsulfonic acids, naphthalenesulfonic acids (Morwet types, Akzo Nobel) and dibutylnaphthalenesulfonic acid (Nekal types, BASF AG), and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol types Clariant), polycarboxylates (BASF AG, Sokalan types), polyalkoxylates, polyvinylamine (BASF AG, Lupamine types), polyethyleneimine (BASF AG, Lupasol types), polyvinylpyrrolidone and copolymers thereof.

A surfactant may increase solubility of an active ingredient in a solution. A surfactant may also affect spray retention, droplet spreading, and dry rates. A surfactant may be anionic or nonionic. Examples of specific anionic surfactants include phosphoric mono- and di-esters of long-chain alcohols having 14 to 22 carbon atoms and the salts thereof; phosphoric mono- and di-esters of alkylene oxide addition products of long-chain alcohols having 14 to 22 carbon atoms and the salts thereof; alkylsulfates having 14 to 22 carbon atoms; polyoxyethylene alkyl ether sulfates of alcohols having 14 to 22 carbon atoms; alkane sulfonates having 14 to 22 carbon atoms; and olefin sulfonates having 14 to 22 carbon atoms.

Suitable non-ionic surfactants include, for example, alkyl-end-capped surfactants, ethoxylated fatty acids, alcohol ethoxylates, tristyrylphenol ethoxylates, ethoxylated sorbitan fatty acid esters or mixtures thereof. Ethoxylated fatty acids include castor or canola oil ethoxylates having at least 25, preferably 27 to 37 ethoxy units, such as Sunaptol® CA350 (castor oil ethoxylate with 35 ethoxy units) of Unigema (formerly ICI Surfactants), Mergital® EL33 (castor oil ethoxylate with 33 ethoxy units) of Henkel KGaA, Eumulgin® C03373 (canola oil ethoxylate with 30 ethoxy units) of Henkel KGaA and Ukanil® 2507 (castor oil ethoxylate) of Unigema.

Surfactants may be present in any desired amount. For example, a surfactant may be present in an amount of about 0.1 to about 30% by weight in the formulation. In a particular embodiment, a surfactant is present in an amount of about 1 to about 20% by weight in the formulation. In another embodiment, a surfactant is present in an amount of about 5 to about 15% by weight in the formulation.

An emulsifier is a type of surfactant typically used to keep emulsion well dispersed. Non-limiting examples of the emulsifier include Aerosol OT-100, Genapol XM 060, Synperonic A20, Soprophor BSU, Dehypon G2084, Rhodacal 70/B, Atlox 4817B, Nansa EVM 70/2E, Phenyl Sulphonate CAL, Agent 2201-76E, Agent 2201-76, Agent 2416-20, Emulpon CO-360, T-Det C-40®, and Agnique™ SBO-10. Agent 2201-76 is manufactured by Stepan Company (22 W. Frontage Road, Northfield, Illinois), which is a blend of nonionic and anionic surfactants (82%). The ingredients in Agent 2201-76 are alkylbenzene sulfonate and fatty acid ethoxylate, aromatic petroleum hydrocarbon, 1-hexanol and naphthalene. Agent 2416-20 is also manufactured by Stepan Company (22 W. Frontage Road, Northfield, Illinois), which is a blend of nonionic and anionic surfactants (35-37%). Agent 2416-20 also includes aromatic petroleum hydrocarbon (57-58%), and naphthalene (6-7%). Emulpon CO-360 is manufactured by Akzo Nobel Chemicals Ltd. (525 West Van Buren, Chicago, Illinois), which contains ethoxylated castor oil (100% by weight) and oxirane (0.001% by weight). T-Det C-40® may be purchased from Harcros Organics (5200 Speaker Road., P.O. Box 2930, Kansas City, Kansas), or from Akzo Nobel Chemicals Ltd. (525 West Van Buren, Chicago, Illinois), which is a non-ionic emulsifier, and a brand of ethoxylated (polyethoxylated) castor oil. Agnique™ SBO-10 is manufactured by Cognix GmbH headquartered in Monheim, Germany, which contains alkoxylated triglycerides as an ethoxylated soybean oil.

A crop oil, or a crop oil concentrate, may be used to increase the efficacy of an herbicide formulation. Although not wishing to be bound by any particular theory, a crop oil is believed to keep the leaf surface moist longer than water, which in turn allows more time for the herbicide to penetrate, thereby increasing the amount of herbicide that will enter the plant (e.g. weed). A crop oil can improve uptake of herbicide by plant (e.g. weed). A crop oil can therefore improve, enhance, increase or promote weed control efficacy or activity. Crop oils may contained from 1% to 40% by weight, or 1% to 20% by weight in the formulation. A crop oil can be derived from either petroleum oil or vegetable oil. Non-limiting examples of crop oil include soybean oils and petroleum based oils.

The compositions can be in customary formulations. Non-limiting examples include solutions, emulsions, suspensions, wettable powders, powders, dusts, pastes, soluble powders, granules, pellets, emulsifiable concentrate, oil spray, aerosol, natural and synthetic materials impregnated with active compound, and very fine capsules (e.g. in polymeric substances). In certain embodiments, the composition is in a form of an emulsifiable concentrate, wettable powder, granule, dust, oil spray or aerosol.

The formulations may optionally include adherent coatings. Such coatings include those that aid the active ingredient to adhere to the intended environment, for example, a weed. Adherent coatings include carboxymethylcellulose, natural and synthetic polymers in various forms, such as powders, granules or latexes. Other adherent coatings include gum arabic, polyvinyl alcohol and polyvinyl acetate.

Phospholipids, such as cephalins and lecithins, and synthetic phospholipids are also examples of adherent coatings. Further additives may be mineral and vegetable oils.

Examples of adhesives are polyvinylpyrrolidone, polyvinyl acetate, polyvinyl alcohol and tylose.

Suitable inert auxiliaries are, for example, the following: mineral oil fractions of medium to high boiling point, such as kerosene and diesel oil, furthermore coal tar oils and oils of vegetable or animal origin, aliphatic, cyclic and aromatic hydrocarbons, for example paraffin, tetrahydronaphthalene, alkylated naphthalenes and their derivatives, alkylated benzenes and their derivatives, alcohols such as methanol, ethanol, propanol, butanol and cyclohexanol, ketones such as cyclohexanone or strongly polar solvents, for example amines such as N-methylpyrrolidone, and water.

Suitable carriers include liquid and solid carriers. Liquid carriers include e.g. non-aqueous solvents such as cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water as well as mixtures thereof. Solid carriers include e.g. mineral earths such as silicas, silica gels, silicates, talc, kaolin, limestone, lime, chalk, bole, loess, clay, dolomite, diatomaceous earth, calcium sulfate, magnesium sulfate and magnesium oxide, ground synthetic materials, fertilizers such as ammonium sulfate, ammonium phosphate, ammonium nitrate and ureas, and products of vegetable origin, such as cereal meal, tree bark meal, wood meal and nutshell meal, cellulose powders, or other solid carriers.

Colourants can also be included in the formulations. Non-limiting examples are inorganic pigments, such as iron oxide, titanium oxide and Prussian Blue, and organic dyestuffs, such as alizarin dyestuffs, azo dye-stuffs and metal phthalocyanine dyestuffs, and trace nutrients such as salts of iron, manganese, boron, copper, cobalt, molybdenum and zinc.

The compositions can be applied in the form of ready mixes. The compositions can also be formulated individually and mixed upon use, i.e. applied in the form of tank mixes.

The compositions can be used as such or in the form of their formulations, and furthermore also as mixtures with other herbicides, ready mixes or tank mixes.

For example, but not limited to: ALS inhibitor herbicide, auxin-like herbicides, glyphosate, glufosinate, sulfonylureas, imidazolinones, bromoxynil, delapon, dicamba, cyclohezanedione, protoporphyrionogen oxidase inhibitors, 4-hydroxyphenyl-pyruvate-dioxygenase inhibitors herbicides. Such herbicides are also contemplated in general for augmenting the effect in weed control described herein.

The compositions may also be mixed with other active compounds, such as fungicides, insecticides, acaricides, nematicides, bird repellents, growth substances, plant nutrients and agents which improve soil structure. For particular application purposes, in particular when applied post-emergence, formulations such as mineral or vegetable oils which are tolerated by plants (for example the commercial product “Oleo DuPont 1 IE”) or ammonium salts such as, for example, ammonium sulphate or ammonium thiocyanate, as further additives can be included.

The compositions may also exclude any of the aforementioned. For example, other herbicides, fungicides, insecticides, acaricides, nematicides, bird repellents, growth substances, plant nutrients and agents which improve soil structure can be excluded or omitted from a composition.

The compositions can be used as such, in the form of their formulations or in the forms prepared therefrom by dilution of a concentrated form, such as ready-to-use or concentrated liquids, solutions, suspensions, emulsions, or solids, such as, powders, pastes, granules and pellets. They are dispersed in the customary manner, for example by watering, irrigation, spraying, atomizing, spot treatment, dusting or scattering.

According to a specific embodiment, the application is by air application.

According to a specific embodiment, the application is by ground application.

According to a specific embodiment, the minimum time from application to harvest is at least 5 days (e.g., and up to 90 days), e.g., at least 7, 14, 15, 20, 21, 30, 35, 40, 45, 60, 70, or 90 days.

Formulations can be produced by mixing or suspending one or more stabilizers, an active ingredient, and optionally an adjuvant, a diluent or a solvent. In certain embodiments, formulations can be produced, for example by first mixing or suspending one or more stabilizers with a diluent or solvent. Next, the appropriate amount of adjuvants is combined to the resulting mixture containing the stabilizers. An active ingredient, cyclohexanedione oxime, can added at the end and blended until the formulation becomes mostly or entirely homogeneous.

Formulations can include one or more solvents. The amount of solvents in a formulation may range from 1% to 99%, or from 30% to 80%. Suitable solvents include, for example, a non-polar water-immiscible solvent, or a polar aprotic water miscible organic solvent. Non-polar solvents include, for example, substituted or unsubstituted aliphatic or aromatic hydrocarbons and esters of plant oils or mixtures thereof. Non-limiting examples of aromatic hydrocarbons include benzene or substituted benzene derivatives such as toluene, xylene, 1,2,4-trimethylbenzene, naphthalene or mixtures thereof. In one embodiment, a solvent includes a mixture of napthalen and 1,2,4-trimethylbenzene. In another embodiment, a solvent is Aromatic 150, a heavy aromatic naptha solvent containing <10% naphthalene and <1.7% 1,2,4-trimethylbenzene.

Alkyl esters can also be used as non-polar, water immiscible solvents. Plant oils may be esterified with various alcohols to form alkyl esters of plant oils. Fatty acids of these plant oils have 5 to 20, or 6 to 15 carbon atoms. Alkyl esters of plant oils include, without limitation, methyl, ethyl and butyl esters of canola (B. napus), linseed, safflower (Carthamus tinctorius L), soybean and sunflower oils. In one embodiment, the solvent is a mixture of methyl esters. A specific non-limiting example of methyl esters is Agent 2416-21 manufactured by Stepan Company (22 W. Frontage Road, Northfield, Illinois).

Water-miscible polar aprotic solvents include, for example, alkyl lactates, isopropyl lactate, alkyl carbonates, polyethylene glycols, polyethylene glycol alkyl ethers, polypropylene glycols, and polypropylene glycol alkyl ethers, or mixtures thereof.

The compositions can be used in any agronomically acceptable format. For example, these can be formulated as ready-to-spray aqueous solutions, powders, suspensions; as concentrated or highly concentrated aqueous, oily or other solutions, suspensions or dispersions; as emulsions, oil dispersions, pastes, dusts, granules, or other broadcastable formats.

As used herein “applying” refers to any means of applying known in the art, either manually or automatic application. Thus, the herbicide compositions can be applied by any means known in the art, including, for example, spraying, atomizing, dusting, spreading, watering. The use forms depend on the intended purpose; in any case, they should ensure the finest possible distribution of the active ingredients according to the invention.

In one embodiment, the compositions may be used to control the growth of weeds that may be found growing in the vicinity of the herbicide-tolerant plants invention. In embodiments of this type, the composition may be applied to a plot in which broadleaf weeds are growing in vicinity to crop. According to another embodiment, the plot comprises only weeds without crop.

According to a specific embodiment, the effective amount is Gold standard or an amount authorized by a regulatory agency.

According to another specific embodiment, the effective amount of ACCase inhibitor is below Gold standard or an amount authorized by a regulatory agency.

As used herein “below Gold standard” refers to at least 10%, 20%, 30%, 40% and even 80% less the amount recommended by the label.

Exemplary doses which are considered Gold standard are provided below.

TABLE 1C

| Mode of | Chemical | | |
|---|---|---|---|
| Action | Families | Herbicide | Dose (g Active Substance ha⁻¹) |
| | | | Alopecurus myosuroides |
| ACCase | FOP | Propaquizafop | 25, 50, 100, 150, 200, |
| | | | 400, 800 and 0 |
| | DIM | Cycloxydim | 50, 100, 200, 300, 400, |
| | | | 800, 1600 and 0 |
| ALS | SU | Mesosulfuron + | 3.8 + 1.3, 7.5 + 2.5, 15 + 3, |
| | | iodosulfuron | 22.5 + 7.5, 30 + 10, 60 + 20, |
| | | | 120 + 40 and 0 |
| | | | Lolium multiflorum |
| ACCase | DEN | Pinoxaden | 7.6, 15.1, 30.3, 45,4, |
| | | | 60.5, 121, 242 and 0 |
| | FOP | Propaquizafop | 37.5, 75, 150, 225, |
| | | | 300, 600, 1200 and 0 |
| | DIM | Cycloxydim | 37.5, 75, 150, 225, |
| | | | 300, 600, 1200 and 0 |
| ALS | SU | Mesosulfuron + | 3.8 + 13, 7.8 + 2.5, 15 + 5, |
| | | iodosulfuron | 22.5 + 7.5, 30 + 10, 60 + 20, |
| | | | 120 + 40 and 0 |
| | TP | Pyroxsulam | 4.7, 94, 18.8, 28.1, 37.5, |
| | | | 75.0, 150.8 and 0 |

According to a specific embodiment, a predominant amount of at least 20%, 30%, 40%, 50%, 60%, 70% or more plants of the weed species of interest in a growth area are at said the flowering window at said applying.

According to a specific embodiment, applying is effected when an amount of said weed species of interest is above 40 plants/acre (e.g., at least 50, 60, 80 or 1000 plants/acre). According to a specific embodiment, the effective amount of the ACCase inhibitor is such that reduces seed set, and/or affects the reproductive organs, such as the pollen or stigma, as compared to control plants of the same species and developmental stage not subject to ACCase inhibition.

These can be qualified according to parameters which are well known in the art, typically by measuring average: abortion rate, fertile fruits, seed weight, seed set, stem length, pods number fruit number per plant/spike/inflorescence/growth area.

As used herein “reduction” or “decrease”| or any grammatical deviation thereof refers to at least 10%, 20%, 30%, 40%, 50%, 60%, 70%, 80%, 90% and even 100% less the amount as compared to that in control plants of the same species and growth conditions not having been subjected to the treatment (ACCase inhibition).

According to a specific embodiment, the effective amount causes female sterility, i.e., affects female reproductive organs.

According to a specific embodiment, the effective amount causes male sterility, i.e., affects female reproductive organs.

According to a specific embodiment, applying is on male plant and not on female (precision tools may be needed).

According to a specific embodiment, applying is on female weed plant and not on male female (precision tools may be needed).

According to a specific embodiment, applying is on male and female flowers or hermaphrodites.

As used herein “broadleaf weed species” refers to weeds in which at the seedling stage and in contrast to grasses, the plants usually have wider leaves with net-like venation. Broadleaves are dicots and have two cotyledons or seed-leaves. These usually emerge above the soil and expand to become the first visible “leaves.” The true leaves then develop above the cotyledons. However, in some broadleaf species, the cotyledon (seed) remains in the soil and the plumule (growing point and cluster of undeveloped true leaves) emerges above the soil line. The shape and size of the cotyledons and first true leaves vary considerably among species. Leaves may be alternate or opposite in arrangement on the stem. In some cases, the second leaf may appear so closely behind the first leaf that they appear to be opposite but later prove to be alternate. The true leaves of broadleaf weeds usually have a petiole (leaf stalk). However, in some species, the true leaves may be sessile (without a leaf petiole). Leaf petioles in the Buckwheat (Polygonaceae) plant family are encircled by a membranous sheath, called an ochrea. Cotyledons are usually hairless but may be rough, while true leaves and plant stems may be hairy or smooth. Seedlings may have an erect stem, be viny or twining in growth habit or be prostrate (growing flat on the ground).

According to a specific embodiment, the broadleaf weed is perennial.

Examples of broadleaf families of weeds which are contemplated for control, according to some embodiments of the invention include, but are not limited to:

Amaranth family (Amaranthaceae), Aster family (Asteraceae), Bedstraw family (Rubiaceae), Brackenfern family (Dennstaedtiaceae), Carnation family (Caryophyllaceae), Carpetweed family, (Molluginaceae), Crowfoot family (Ranunculaceae), Dayflower family (Commelinaceae), Evening-primrose family (Onagraceae), Geranium family (Geraniaceae), Leafflower family (Phyllanthaceae), Legume family (Fabaceae), Mallow family (Malvaceae), Melon family (Cucurbitaceae), Milkweed family (Apocynaceae), Mint family (Lamiasceae), Morningglory family (Convolvulaceae), Mustard family (Brassicaceae), Nightshade family (Solanaceae), Pennywort family (Araliaceae), Plantain family (Plantaginaceae), Purslane family (Portulacaceae), Smartweed family (Polygonaceae), Spurge family (Euphorbiaceae), Vervain family (Verbenaceae), Woodsorrel family (Oxalidaceae).

According to a specific embodiment, the broadleaf weed species of interest is selected from the group consisting of Amaranthus species—A. albus, A. blitoides, A. hybridus, A. palmeri, A. powellii, A. retroflexus, A. rudis, A. spinosus, A. tuberculatus, and A. viridis; Ambrosia species—A. trifida, A. artemisifolia; Euphorbia species—E. heterophylla; Kochia species—K. scoparia; Conyza species—C. bonariensis, C. canadensis, C. sumatrensis; Plantago species—P. lanceolata, Chenopodium species—C. album; Abutilon theophrasti, Ipomoea species, Sesbania, species, Cassia species, Sida species and Solanum species.

According to a specific embodiment, the broadleaf weed species of interest is selected from the group consisting of Amaranthus palmeri, Amaranthus tuberculatus, Solanum nigrum, Abutilon theophrasti and Conyza bonariensis According to some embodiments of the invention, the weed species is of the Amaranth family. Examples include, but are not limited to, the species below:

Amaranthus acanthochiton—greenstripe, Amaranthus acutilobus—a synonym of Amaranthus viridis, Amaranthus albus—white pigweed, tumble pigweed, Amaranthus anderssonii, Amaranthus arenicola—sandhill amaranth, Amaranthus australis—southern amaranth, Amaranthus bigelovii—Bigelow's amaranth, Amaranthus blitoides—mat amaranth, prostrate amaranth, prostrate pigweed, Amaranthus blitum—purple amaranth, Amaranthus brownii—Brown's amaranth, Amaranthus californicus—California amaranth, California pigweed, Amaranthus cannabinus—tidal-marsh amaranth, Amaranthus caudatus—love-lies-bleeding, pendant amaranth, tassel flower, quilete Amaranthus chihuahuensis—Chihuahuan amaranth, Amaranthus crassipes—spreading amaranth, Amaranthus crispus—crispleaf amaranth, Amaranthus cruentus—purple amaranth, red amaranth, Mexican grain amaranth, Amaranthus deflexus—large-fruit amaranth, Amaranthus dubius—spleen amaranth, khada sag, Amaranthus fimbriatus—fringed amaranth, fringed pigweed, Amaranthus floridanus—Florida amaranth, Amaranthus furcatus, Amaranthus graecizans, Amaranthus grandiflorus, Amaranthus greggii—Gregg's amaranth, Amaranthus hybridus—smooth amaranth, smooth pigweed, red amaranth, Amaranthus hypochondriacus—Prince-of-Wales feather, prince's feather, Amaranthus interruptus—Australian amaranth, Amaranthus minimus, Amaranthus mitchellii, Amaranthus muricatus—African amaranth, Amaranthus obcordatus—Trans-Pecos amaranth, Amaranthus palmeri—Palmer's amaranth, Palmer pigweed, careless weed, Amaranthus polygonoides—tropical amaranth, Amaranthus powellii—green amaranth, Powell amaranth, Powell pigweed Amaranthus pringlei—Pringle's amaranth, Amaranthus pumilus—seaside amaranth, Amaranthus quitensis—Mucronate Amaranth, Amaranthus retroflexus—red-root amaranth, redroot pigweed, common amaranth, Amaranthus saradhiana, Amaranthus scleranthoides—variously Amaranthus sclerantoides, Amaranthus scleropoides—bone-bract amaranth, Amaranthus spinosus—spiny amaranth, prickly amaranth, thorny amaranth, Amaranthus standleyanus, Amaranthus thunbergii—Thunberg's amaranth, Amaranthus torreyi—Torrey's amaranth, Amaranthus tricolor—Joseph's-coat, Amaranthus tuberculatus—rough-fruit amaranth, tall waterhemp, Amaranthus viridis—slender amaranth, green amaranth, Amaranthus watsonii—Watson's amaranth, Amaranthus wrightii—Wright's amaranth.

According to a specific embodiment, the weed species is Amaranthus palmeri or Amaranthus tuberculatus.

In some embodiments of the invention, applying the ACCase inhibitor is at a time window restricted to flowering.

As used herein “flowering” refers to any stage of flowering i.e., from flowering induction until anthesis or to fully receptive stigma. Flowers can be unisexual (with either male or female organs) or bisexual (with male stamens and female pistils). Flowering plant species can have separate male and female flowers or hermaphrodites on the same plant (monoecious) or separate male and female individuals within the population (dioecious).

As used herein “flowering induction” refers to switching from a vegetative to a reproductive mode.

The term “flowering” also refers to prior to flowering, when flower organs (non-vegetative portions) are developed to become ready for reproduction. Pre-flowering stages are based on the development of non-vegetative i.e., sexual organs (male part and female part). Flowering is restricted to the presence of a sexual of a reproductive organ or cell.

According to a specific embodiment, flowering does not include an exclusively vegetative stage of germination.

According to a specific embodiment, flowering does not include an exclusively vegetative stage of seedling (e.g., leaf stage 2-4 or 2-6).

The Pre-Flowering stage includes:

1. Pollen Formation—In anther, pollens are formed and developed.

2. Ovary Development—The ovary, the chamber that envelops the ovule, is formed. The tissues in ovule are formed and start developing.

3. Formation of Embryo Sac. The embryo sac, the storage of nutrients for the baby (embryo) to grow until it reaches out of soil and gets own nutrients by photosynthesis, is formed. When the embryo sac is completely developed, the other flower organs are also ready for flowering and fertilization.

Once pollen in the anther (male reproductive part) and the embryo sac in the ovule (female reproductive part) are fully developed, the next stage is flowering, i.e., anthesis.

Stigmas of A. tuberculatus var. rudis unfertilized female flowers can persist indefinitely until pollen reaches them, consistent with observations on another dioecious species, A. cannabinus (Quinn et al. J. Torrey Bot. Soc. 127: 83-86 2000). After fertilization, the stigmas dry out. (Costea et al., Canadian Journal of Plant Science, 2005, 85(2): 507-522).

Anthesis is the period during which a flower is fully open and functional. It may also refer to the onset of that period.

According to a specific embodiment, the determining development of flowers comprises determining pre-flowering.

According to a specific embodiment, the determining development of flowers comprises determining development of inflorescence meristem.

According to a specific embodiment, the determining development of flowers comprises determining anthesis.

According to a specific embodiment, the determining development of flowers comprises identification of female structures.

According to a specific embodiment, the determining development of flowers comprises identification of male structures.

According to a specific embodiment, determining flowering is performed once per plant per (weed or crop) growth season.

According to a specific embodiment, determining flowering is performed multiple times per plant or growth area per (weed or crop) growth season. In this case determining is also referred to as “monitoring”.

Determining flowering can be effected at the individual level or according to a population level at various regions.

Methods of determining pollination are known in the art.

Conventional methods for determining flowering include dissecting plants under magnification to determine the presence of either a vegetative or reproductive structure at the meristem.

A less time-consuming method often used by plant breeders to determine the flowering is to monitor emergence of the inflorescence, otherwise known as “emergence” or “heading time”. Heading time is defined as the moment when the first inflorescence is exerted from the leaf sheaths and becomes visible to the naked eye.

A further method for determining the start of flowering is to monitor anthesis, which is the moment pollen is released from the anthers.

A widely used method for determining the start of flowering in the field involves repeated visual inspection of plots to estimate the number of flowering plants present in a plot. It is conventionally accepted in agronomics that a plot is “flowering” when 50% of plants in a plot exhibit emerged inflorescences. This technique will give a rough idea as to whether a group of plants is flowering.

US Patent Publication No. 20090226042 teaches a method of determining the point at which a plant starts to flower. Accordingly, this can be effected by determining the start of flowering on an individual plant basis by measuring the reproductive structures of plants from digital images of these structures and deducing the start of flowering from the measurements and average growth rates. Also provided is an apparatus for determining the start of flowering in plants, particularly in a high-throughput manner.

According to an embodiment of the application determining flowering comprises the steps of digitally imaging an inflorescence of a plant; and measuring the inflorescence from the digital image; calculating the flowering (e.g., start of) from the average growth rate of inflorescences and the measurements derived from the calculation.

Advantageously, the method of this embodiment of the invention allows the start of flowering to be accurately determined on an individual plant level.

Furthermore, this method provides means to discriminate flowering and non-flowering plants from the presence or absence of an inflorescence.

The dimensions (typically the area, but this may also be the length and/or width) of the inflorescence is measured from the digital image and using this information and the average growth rate for inflorescences (of the plant species or variety in question) one may back calculate the point of emergence of the inflorescence.

According to embodiments of the invention and this embodiment in particular determining development of flowers is effected by integrating plant data and/or field data with literature data such as will be apparent infra.

For example, the average growth rate of an inflorescence of a particular plant species or variety is 10 cm per day, and the observed size of an inflorescence of a plant of the same species or variety is 30 cm, therefore it can be deduced that the inflorescence appeared 3 days before the moment of the observation. Therefore, the start of flowering would also have been 3 days before the moment of the observation.

According to an embodiment of the invention, to determine flowering requires a detectable and measurable inflorescence to be present at the time of imaging, however this need not be the first inflorescence. Thus, contemplated is measuring flowering of first inflorescence, second inflorescence etc. Furthermore, the inflorescence should not have reached its maximum size at the time of imaging. This would require observations of a sufficient frequency so that at least one observation is performed between emergence of the inflorescence and before it reaches its maximum size. The frequency of observations can readily be determined by a person skilled in the art and will of course depend upon the species or variety in question.

Such a method is particularly suited to handling large numbers of plants in a high throughput manner, whilst retaining a high level of accuracy, since flowering can be determined on an individual plant level.

According to a specific embodiment, determining at the level of an individual plant is also advantageous for weed in which flowering is synchronized such as due to environmental reasons. For instance, synchronized flowering is taken place in Amaranthus palmeri (A. palmeri) weed. Korres and Norsworthy (2017), Weed Science, 65(4):491-503 conducted field experiments in Arkansas University during the summers of 2014 and 2015 and they investigated A. palmeri flowering initiation and progress. According to their observations A. palmeri weed emerges at late June and its flowering initiation starts at the end of July or the beginning of August (about 30-40 days after emergence) and continues for approximately 40-50 days. In addition, it has been demonstrated that the flowering period of A. palmeri population is relatively synchronized and it is independent from the plant emergence date as it is regulated by environmental conditions such as day length and temperature (Keeley et. Al, 1987; Weed Science Vol. 35, No. 2 (March, 1987), pp. 199-204; Korres and Norsworthy (2017), Weed Science, 65(4):491-503; Clay et al., 2016; Weed Science Society of America, Annual Meeting. San Juan, Puerto Rico, Feb. 8-11, 2016). Similar observations regarding flowering synchronization were also reported for A. tuberculatus (Wu and Owen, 2014; Weed Science, 62(1):107-117). Hence, integrating field data which determines a pre-flowering stage such as described above is sufficient together with literature data to determine anthesis and pollinating at the relevant stage.

Such methods can be performed using an apparatus for determining flowering, which apparatus typically comprises one or more digital cameras with sufficient resolution for imaging emerging plant inflorescences; and computer means for detecting and measuring plant inflorescences and for deriving the start of flowering from the measurements and average growth rates of inflorescences.

Determining flowering can be effected in situ (e.g., in the field).

In this case, one or more digital cameras are arranged to move over the plants to take images of the plant inflorescences.

According to a specific embodiment, plants are presented to the camera in such a way that individual plants can be discriminated and identified. This allows assessment of population homogeneity for flowering time using existing statistical techniques. Digital cameras suitable for imaging emerging plant inflorescences are typically those allowing the inflorescences imaged to have a minimum size of about 100 pixels.

The computer means for detecting and measuring plant inflorescences comprises image-processing software. Typically, such software uses features specific to inflorescences to distinguish these from, say, vegetative organs (stems and leaves). For example, flowers often exhibit a different color and/or texture than the rest of the plant. Rollin et al., 2016 discusses (Rollin, O., Benelli, G., Benvenuti, S. et al. Agron. Sustain. Dev. (2016) 36: 8.) that flower shape and color play a key role in routing insect foraging flights (Menzel and Shmida 1993). Many Brassicaceae species reflect ultraviolet radiation to attract insect pollinators (Yoshioka et al. 2005). These can be used in a similar way for detection purposes.

For instance, where the range of colors displayed by immature inflorescences is close to that of stems or leaves, the software uses differences in shape and pattern to distinguish from the more granular structure of the inflorescence which results in a higher pixel-to-pixel variation than that of the leaves or stem. Topological cues can also be used to refine detection. For example, inflorescences are usually found at the top of the plant and they are always connected to a stem.

An example of digital images processing of images of weed plants from which the plant inflorescences may be measured. A starting image is subjected to a so-called “thresholding” process involves removal of all non-plant parts. Thresholding is achieved by virtue of the background and non-plant parts exhibiting a different color range to the plant organs. After that an image after thresholding is produced. This is followed by a statistical method termed “color variation analysis” which is applied to the remaining pixels to determine which parts exhibit textural properties akin to that of inflorescences. An image after color variation analysis is prepared. Literature data of inflorescence color and texture would be required for this step, Objects classified as “non-inflorescence” through the process of color variation analysis are removed. Finally, the dimensions of the remaining objects, classified as “inflorescences”, are recorded by the software. Since some parts of the inflorescences can be hidden by other plant parts, such as leaves, it is preferable to refine the measurements by averaging the results obtained from several pictures, say at least 3 pictures or images and generally not more than 6.

Statistical analysis may also be carried out on data collected using the unique identifier. For example, statistical data analysis to determine the start of flowering may be based on the following three steps. The first step corrects for the presence of an inflorescence based on logic rules, i.e. assumes that there is consistency between the six pictures or images taken of any one image, that there are no inflorescences on plants that are smaller than a certain size and that inflorescences do not disappear once present. The second step estimates the speed of inflorescence growth in the entire batch of plants. In this step, inflorescence size is corrected for plant size, an exponential inflorescence growth is assumed in the first week of growth and a date for inflorescence emergence is estimated for each plant. In the third step, population means of the inflorescence emergence date and standard errors on these estimates are calculated based on survival method (Cox models).

If, for example, plants are imaged at weekly intervals, the presence of an inflorescence on an image allows the start of flowering to be determined with a resolution of one week. More thorough data analysis making use of inflorescence size may be used to interpolate between two images and to determine the start of flowering with a lower resolution for individual plants More thorough data analysis making use of inflorescence size may also be used to provide more reliable estimates of the mean start of flowering for a population of plants considering the presence of plants that were not flowering at the time of last imaging.

Additional information may be recorded such as species (e.g., based on light reflectance), date, inflorescence measurements and/or other measurements (e.g., height, plants per plot, density, distribution, geographical location, male and/or female organs), and any other quantitative or qualitative observations made on the plant. Data contained in the database can be retrieved by means of appropriate software.

Molecular determination of transition to flowering such as LEAFY and APETALA 1 in A. thaliana and their respective homologoues FLORICAULA and SQUAMOSA in A. majus (Krizek and Fletcher nature reviews genetics 2005).

Additional information will include identification depending on floral odor and fragrance and relies on volatiles such as described in Schiestl and Marion Poll., 2002.

Therefore, chemical determination of flowering can be used for detection. In Rollin et al., 2016 (Rollin, O., Benelli, G., Benvenuti, S. et al. Agron. Sustain. Dev. (2016) 36: 8.) Olfactory and tactile cues were discussed as insect recognition patterns that can be used also for detection purposes. A mechanism for identification and recognition of flowers also consists in the production and emission of volatile compounds, mainly terpenoids and benzenoids (van Schie et al. 2006). The two dominant components of the fragrance of Cirsium species (Asteraceae), benzaldehyde and phenylacetaldehyde, attract several orders of generalist insect pollinators (Theis 2006). Fragrance of their flowers is emitted in dynamic patterns that maximize pollinator attraction (Theis et al. 2007).

Determination of flowering based on pollen in the air in the growth area is also another measure. The skilled in the art would know how to determine air pollen. For instance, Vurkard volumetric spore trap, which vacuums up air through a slit and captures floating grains. Pollen count can also be measured by attaching a rotating rod with a sticky substance. After 24 hours, the amount of pollen that has adhered to the rod is analyzed.

Yet another method is determining vegetative portions which are often indicative of later flowering. For instance, by counting the number of leaves, which in some weed species is indicative of flowering.

The teachings of each of the following are incorporated by reference here:
PCT Publication No. WO2017/203519;
PCT Publication No. WO2019/106667;
PCT Publication No. WO2019/106666;
PCT Publication No. WO2019/106668;
PCT Publication No. WO2019/215581;
PCT Publication No. WO2019/215582;
PCT Publication No. WO2020/084586.

According to a specific embodiment, a predominant amount of at least 20%, 30%, 40%, 50%, 60% 70%, 80% or more 90-100% of plants of the broadleaf weed species of interest in a growth area are at the flowering window at said applying.

In another embodiment described herein is a method for controlling weeds in a field by application of the composition without significantly inhibiting the growth of a crop plant, the method comprising: (a) providing a crop plant or seed thereof; and (b) applying an effective amount of the composition: (i) to the field, followed by planting of said crop plant or seed in therein; (ii) to the field, during or after planting or sowing therein; (iii) to the plant in said field and to weeds in the vicinity of the plant; (iv) to said seed, followed by planting or sowing in the field; or (v) to a plant after it has been sown in the field, and to weeds in the vicinity of the plant; thereby controlling weeds. In another aspect, the step of applying comprises performing post-emergent treatment of the crop plant by applying an effective amount of the composition to the plant and its immediate vicinity, at a dose rate of about 10 to about 5000 grams active ingredient per hectare (ai/ha), Gold standard, manufacturer's instructions or as described herein. In another aspect, the step of applying comprises performing pre-emergent treatment, or 0 to 30 day-pre-planting treatment, of the crop plant by applying the composition, to the seed planting locus thereof and its immediate vicinity, at a dose rate of about 10 to about 5000 g ai/ha, Gold standard, manufacturer's instructions or as described herein.

According to a specific embodiment, the application is post-emergence.

According to a specific embodiment, the application is according to rate table instructions by the manufacturer.

As mentioned, in order to corroborate the weed control effects, the compositions and methods described herein make use of additional herbicidal compositions which are contemplated for weed control.

According to other embodiments, the present compositions, weed control kits and methods employ pollen for artificial pollination of the weed with pollen of the same target species of interest (e.g., A. palmer). Such a combination is unique as weed control effect is achieved at the F1 generation and not the F0.

As used herein “fitness” refers to the relative ability of the weed species of interest to develop, reproduce or propagate and transmit its genes to the next generation. As used herein “relative” means in comparison to a weed of the same species not having been artificially pollinated with the pollen of the invention and grown under the same conditions.

It will be appreciated that the effect of pollen treatment according to the present teachings is already manifested prior to first generation after fertilization i.e., on the treated plant itself.

The fitness may be affected by reduction in productiveness, propagation, fertility, fecundity, biomass, biotic stress tolerance, abiotic stress tolerance and/or herbicide resistance.

As used herein “productivity” refers to the potential rate of incorporation or generation of energy or organic matter by an individual, population or trophic unit per unit time per unit area or volume; rate of carbon fixation.

As used herein “fecundity” refers to the potential reproductive capacity of an organism or population, measured by the number of gametes.

According to a specific embodiment, the pollen affects any stage of seed development or germination.

According to a specific embodiment, the reduction in productiveness is manifested by at least one of:
(i) inability to develop an embryo;
(ii) embryo abortion;
(iii) seed non-viability;
(iv) seed that cannot fully develop; and/or
(v) seed that is unable to germinate.

It will be appreciated that when pollen reduces the productiveness, fertility, propagation ability or fecundity of the weed in the next generation it may be referred to by the skilled artisan as sterile pollen, though it fertilizes the weed of interest. Hence, pollen as used herein is still able to fertilize but typically leads to seed developmental arrest or seed abortion.

According to a specific embodiment, the reduction in fitness is by at least 10%, 20%, 30%, 40%, 50%, 60%, 70%, 75%, 80%, 85%, 90%, 92%, 95%, 97% or even 100%, within first generation after fertilization and optionally second generation after fertilization and optionally third generation after fertilization.

According to a specific embodiment, the reduction in fitness is by at least 10%, 20%, 30%, 40%, 50%, 60%, 70%, 75%, 80%, 85%, 90%, 92%, 95%, 97% or even 100%, within first generation after fertilization.

According to a specific embodiment, reduced fitness results from reduction in tolerance to biotic or abiotic conditions e.g., herbicide resistance.

As used herein “pollen” refers to viable pollen that is able to fertilize the weed species of interest and therefore competes with native pollination.

Alternatively, when native pollen competition does not exist, or very low levels of native pollen are present, pollination by the designed pollen inhibits apomixis of weeds and by this reduces their quantities as well [Ribeiro et al. 2012 Abstracts of the Weed Science Society of America Annual Meeting. www(dot)wssaabstracts(dot)com/public/9/abstract-438(dot)html].

According to a specific embodiment, the pollen is of the same species as of the target weed (e.g., invasive, aggressive weed).

According to a specific embodiment, the pollen exhibits susceptibility to a single growth condition e.g., herbicide, temperature.

According to a specific embodiment, the pollen exhibits susceptibility to multiple growth conditions e.g., different herbicides.

According to a specific embodiment, the pollen is non-genetically modified.

The pollen may therefore be of a naturally occurring plant that reduces the fitness of the at least one weed species of interest. According to a specific embodiment, A. palmeri or A. tuberculatus susceptible seeds are available from the Agriculture Research Service National Plant Germplasm System plant introduction (USDA-ARS_NPGS PI) as well as from various locations in Israel.

Alternatively or additionally, the pollen may be of a plant that has been selected towards producing pollen that reduces the fitness of the at least one weed species of interest.

Selection can be effected by way of exposing the weed to various concentrations of, for example, a herbicide or a plurality of different herbicides, and selecting individuals which show increased susceptibility to the herbicide or different herbicides. Alternatively or additionally, different plants exhibiting susceptibility to different herbicides can be crossed to generate a plant exhibiting susceptibility to a number of herbicides of interest.

It will be appreciated that such breeding need not engage into pedigree breeding programs as the mere product is the pollen of a weedy plant.

According to a specific embodiment, there is provided a method of producing pollen that reduces fitness of at least one weed species of interest, the method comprising treating the weed species of interest (e.g., seeds, seedlings, tissue/cells) or pollen thereof with an agent that reduces fitness.

When needed (such as when treating that weed (e.g., seeds, seedlings, tissue/cells) the method further comprises growing or regenerating the plant so as to produce pollen.

According to a specific embodiment, the method comprises harvesting pollen from the weed species of interest following treating with the agent that reduces the fitness.

It will be appreciated that the pollen may be first harvested and then treated with the agent (e.g., radiation) that reduces the fitness of the weed species of interest.

Alternatively or additionally, the pollen is produced from a plant having an imbalanced chromosome number (genetic load) with the weed species of interest.

Thus, for example, when the weed of interest is diploid, the plant producing the pollen is treated with an agent rendering it polyploid, typically, tetraploids are selected, such that upon fertilization with the diploid female plant an aborted or developmentally arrested, not viable seed set are created. Alternatively, a genomically imbalanced plant is produced which rarely produces a seed set.

According to a specific embodiment, the weed (or a regenerating part thereof or the pollen) is subjected to a polyploidization protocol using a polyploidy inducing agent that produces plants which are able to cross but result in reduced productiveness.

Thus, according to some embodiments of the invention, the polyploid weed has a higher chromosome number than the wild type weed species (e.g., at least one chromosome set or portions thereof) such as for example two folds greater amount of genetic material (i.e., chromosomes) as compared to the wild type weed. Induction of polyploidy is typically performed by subjecting a weed tissue (e.g., seed) to a G2/M cycle inhibitor.

Typically, the G2/M cycle inhibitor comprises a microtubule polymerization inhibitor.

Examples of microtubule cycle inhibitors include, but are not limited to oryzalin, colchicine, colcemid, trifluralin, benzimidazole carbamates (e.g. nocodazole, oncodazole, mebendazole, R 17934, MBC), o-isopropyl N-phenyl carbamate, chloroisopropyl N-phenyl carbamate, amiprophos-methyl, taxol, vinblastine, griseofulvin, caffeine, bis-ANS, maytansine, vinbalstine, vinblastine sulphate and podophyllotoxin.

According to a specific embodiment, the microtubule cycle inhibitor is colchicine.

Still alternatively or additionally, the weed may be selected producing pollen that reduces fitness of the weed species of interest by way of subjecting it to a mutagenizing agent and if needed further steps of breeding.

Thus, weed can be exposed to a mutagen or stress followed by selection for the desired phenotype (e.g., pollen sterility, herbicide susceptibility).

Examples of stress conditions which can be used according to some embodiments of the invention include, but are not limited to, X-ray radiation, gamma radiation, particle irradiation such as alpha, beta or other accelerated particle, UV radiation or alkylating agents such as NEU, EMS, NMU and the like. The skilled artisan will know which agent to select.

According to a specific embodiment, the stress is selected from the group consisting of X-ray radiation, gamma radiation, UV radiation. For example. Pollen of the weed can be treated with the agent that reduces the fitness (e.g., radiation) following harvest.

Guidelines for plant mutagenesis are provided in K Lindsey Plant Tissue Culture Manual—Supplement 7: Fundamentals and Applications, 1991, which is hereby incorporated in its entirety.

Other mutagenizing agents include, but are not limited to, alpha radiation, beta radiation, neutron rays, heating, nucleases, free radicals such as but not limited to hydrogen peroxide, cross linking agents, alkylating agents, BOAA, DES, DMS, EI, ENH, MNH, NMH Nitrous acid, bisulfate, base analogs, hydroxyl amine, 2-Naphthylamine or alfatoxins.

According to a specific embodiment, the radiation is X-ray radiation.

According to a specific embodiment, the dose of radiation (X-ray) is 150-300 Gy e.g., 150, 200, 250 or 300 Gy, such as in the case of Amaranthus genues (e.g., A. palmeri).

Alternatively or additionally, the pollen may be genetically modified pollen (e.g., transgenic pollen, DNA-editing).

Numerous methods are known for exploiting genetic modification to render it suitable for reducing the fitness of a weed species of interest.

Thus, according to a specific embodiment, the pollen is genetically modified pollen.

According to other specific embodiments, the trait being inherited upon artificial pollination with the pollen of the invention is selected from the group consisting of embryo abortion, seed non-viability, seeds with structural defects, seeds that are unable to germinate, abiotic/biotic stress susceptibility (e.g., herbicide susceptibility) or induced death or sensitivity upon chemical or physical induction or any other inherited property that will enable controlled reduction of weed population size.

Often sterile pollen results in a seedless plant. A plant is considered seedless if it is not able to produce seeds, traces of aborted seeds or a much-reduced number of seeds. In other cases the pollen will produce plants with seeds that are unable to germinate or develop e.g., no embryo or embryo abortion.

According to a specific embodiment, the pollen is genetically modified to express an exogenous transgene that upon fertilization will reduce fitness of the weed of interest (next generation). Such a gene is termed a “disrupter gene”. According to some embodiments, the disrupter gene causes kills the weed species of interest, accordingly it is termed a “death gene”.

According to a further aspect of the invention there is provided a method of producing pollen, the method comprising:
(a) growing weed producing pollen that reduces fitness of at least one weed species of interest; and
(b) harvesting the pollen.

Thus the pollen product producing weed is grown in dedicated settings, e.g., open or closed settings, e.g., a greenhouse. According to a specific embodiment, the growth environment for the manufacture of the pollen does not include crop plants or the weed species of interest. For example, the growth area includes an herbicide susceptible weed variant but not an herbicide resistant weed variant (of the same species). Another example, the growth environment comprises a GM weed with a destructor gene the weed being fertile and producing pollen, but doesn't include the weed in which the destructor gene is expressed.

According to a specific embodiment, growing the weed producing pollen that reduces fitness is effected in a large scale setting (e.g., hundreds to thousands m²).

According to some embodiments of the invention, the weed producing pollen comprises only male plants.

Harvesting pollen is well known in the art. For example, by the use of paper bags. Another example is taught in U.S. 20060053686, which is hereby incorporated by reference in its entirety.

Once pollen is obtained it can be stored for future use. Examples of storage conditions include, but are not; limited to, storage temperatures in Celsius degrees e.g., −196, −160, −130, −80, −20, −5, 0, 4, 20, 25, 30 or 35; percent of relative humidity e.g., 0, 10, 20, 30, 40, 50, 60, 70, 80, 90 or 100. Control over humidity can be achieved by using a dehydrating agent as known in the art. Additionally, the pollen can be stored in light or dark.

Alternatively, the pollen product of the present teachings is subjected to a post-harvest treatment.

Thus, according to an aspect of the invention there is provided a method of producing pollen for use in artificial pollination, the method comprising:
(a) obtaining pollen that reduces fitness of at least one weed species of interest, e.g., as described herein; and
(b) treating the pollen for use in artificial pollination.

Accordingly, there is provided a composition of matter comprising weed pollen that reduces fitness of at least one weed species of interest, the pollen having been treated for improving its use in artificial pollination.

Examples of such treatments include, but are not limited to coating, priming, formulating, chemical inducers, physical inducers [e.g., potential inducers include, but are not limited to, ethanol, hormones, steroids, (e.g., dexamethasone, glucocorticoid, estrogen, estradiol), salicylic acid, pesticides and metals such as copper, antibiotics such as but not limited to tetracycline, Ecdysone, ACEI, Benzothiadiazole and Safener, Tebufenozide or Methoxyfenozide], solvent solubilization, drying, heating, cooling and irradiating (e.g., gamma, UV, X-ray, particle).

Additional ingredients and additives can be advantageously added to the pollen composition of the present invention and may further contain sugar, potassium, calcium, boron, and nitrates. These additives may promote pollen tube growth after pollen distribution on flowering plants.

In some embodiments, the pollen composition of the present invention contains dehydrated or partially dehydrated pollen.

Thus, the pollen composition may comprise a surfactant, a stabilizer, a buffer, a preservative, an antioxidant, an extender, a solvent, an emulsifier, an invert emulsifier, a spreader, a sticker, a penetrant, a foaming agent, an anti-foaming agent, a thickener, a safener, a compatibility agent, a crop oil concentrate, a viscosity regulator, a binder, a tacker, a drift control agent, a fertilizer, a timed-release coating, a water-resistant coating, an antibiotic, a fungicide, a nematicide, a herbicide or a pesticide.

According to a specific embodiment, the ACCase inhibitor (e.g., clethodim) formulation includes a stabilizer.

As used herein, the terms “stabilization” or “stabilized,” refers to an ACCase inhibition composition with increased chemical and/or physical stability, or reduced degradation, as compared to an unstabilized composition. The extent of stabilization can be measured by activity of the ACCase inhibitor, or the amount of active (un-degraded) ACCase inhibitor. Such a stabilizer can be epoxidized oil or ester. The epoxidized oil or ester include and can be derived from animal or vegetable fatty acids. Non limiting examples of animal fatty acids include butter, lard, tallow, grease, herring, menhaden, pilchard, sardine, and babassu. Non limiting examples of plant fatty acids include castor, coconut, corn, cottonseed, jojoba, linseed, oiticica, olive, palm, palm kernel, peanut, rapeseed, safflower, soya, sunflower, tall, and tung. Common epoxidized vegetable oil fatty acids and esters include and can be derived from soybean and linseed oils. Specific non-limiting examples of epoxidized oils are PARAPLEX® G-60 (epoxidized soybean oil) and PARAPLEX® G-62 (epoxidized soybean oil) manufactured by the Hallstar Company (120 S. Riverside Plaza, Suite 1620, Chicago, Ill.). Suitable epoxidized esters of fatty acids include, for example, monoesters and diesters of fatty acids. Examples of glycols from which a suitable ester can be derived from include, but are not limited to, propylene glycol, dipropylene glycol, ethylene glycol and diethylene glycol. Fatty acids derived from vegetable oils include fatty acids containing carbon chains of about 2 to about 24 carbons, about 12 to about 24 carbons, or about 16 to about 18 carbons. The fatty acid may be unsaturated. The one or more sites of unsaturation can be epoxidized by methods known in the art. Fatty acid chains can have one or more oxirane rings. Thus, a fatty acid that has multiple sites of unsaturation can be epoxidized to a greater extent (i.e. have 2, 3, 4, 5, 6, or more epoxides at any position). However, not all double bonds of the fatty acid chain must be epoxidized. A fatty acid chain containing one oxirane ring formed between two adjacent carbons of the carbon chain is a fatty acid from which a suitable ester can be derived. Fatty acids with multiple sites of unsaturation can have one or more double bonds so long as at least one oxirane ring is embedded in adjacent carbons as described above. A fatty acid may contain one or more epoxides (or epoxide groups). The epoxides can be located at any position on the fatty acid carbon chain. For example, an epoxide can be located at C-9 (i.e. 9,10-epoxide) or at C-12 (i.e. 12,13-epoxide) of a fatty acid carbon chain. Specific non-limiting examples of fatty acids include, but are not limited to, palmitic acid (hexadecanoic acid), palmitoleic acid (9-hexadecenoic acid), stearic acid (octadecanoic acid), oleic acid (9-octadecenoic acid), ricinoleic acid (12-hydroxy-9-octadecenoic acid), vaccenic acid (11-octadecenoic acid), linoleic acid (9,12-octadecadienoic acid), alpha-linolenic acid (9,12,15-octadecatrienoic acid), gamma-linolenic acid (6,9,12-octadecatrienoic acid), arachidic acid (eicosanoic acid), gadoleic acid (9-eicosenoic acid), arachidonic acid (5,8,11,14-eicosatetraenoic acid), and erucic acid (13-docosenoic acid).

The term “epoxide” used herein refers to three membered cyclic ether (also called an oxirane or or alkylene oxide) in which an oxygen atom is joined to each of two carbon atoms that are bonded to each other. Epoxides undergo reactions such as C-0 bond cleavage, nucleophilic addition, hydrolysis and reduction under mild conditions and more rapidly than other ethers. Epoxides are formed by some oxidation reactions of alkenes with peracids. The epoxy functionality is believed to contribute to stability (e.g., against heat and light).

In certain embodiments, a stabilizer is a propylene glycol monoester, methyl ester or allyl ester of an oil fatty acid. In additional embodiments, a stabilizer is 9-octadecenoic acid (Z)-, epoxidized, ester with propylene glycol. In further embodiments, a stabilizer is fatty acid, soya, epoxidized, or 2-ethylhexyl ester.

The percentage by weight of the stabilizer in a formulation of the invention can be between about 0.1% and 15%, between about 1% and 10%, or between about 1% and 5%. Typically the amount of a stabilizer, (e.g. by weight) will be less than the amount of an active ingredient. However, the amount may be determined based upon a particular stabilizer and active ingredient, optionally in combination with other ingredients, such as solvent/diluent and adjuvants. Typically, a formulation having from 3% to 8% of adjuvant may comprise from 1% to 5% stabilizer; a formulation having from 8% to 16% of adjuvant may comprise from 1% to 10% of stabilizer; and a formulation having from 17% to 30% adjuvant may comprise from 1% to 15% stabilizer.

Other ingredients and further description of the above ingredients is provided hereinbelow.

Additional exemplary embodiments of formulations which are contemplated herein are disclosed in US20110015074, U.S. Pat. No. 8,216,976, US20060183642, US20060199738, US20060205600, US20060223710, US20070142228, U.S. Pat. No. 7,651,977, G02014871D0, WO2016196130, each of which is incorporated herein by reference in its entirety.

Under ordinary conditions of storage and use, the composition of the present invention may contain a preservative to prevent the growth of microorganisms.

The preventions of the action of microorganisms can be brought about by various antibacterial and antifungal agents, for example, parabens, chlorobutanol, sorbic acid, and the like. Antioxidants may also be added to the pollen suspension to preserve the pollen from oxidative damage during storage. Suitable antioxidants include, for example, ascorbic acid, tocopherol, sulfites, metabisulfites such as potassium metabisulfite, butylhydroxytoluene, and butylhydroxyanisole.

Thus, pollen compositions that may also be used but not limited to mixtures with various agricultural chemicals and/or herbicides, insecticides, miticides and fungicides, pesticidal and biopesticidal agents, nematocides, bactericides, acaricides, growth regulators, chemosterilants, semiochemicals, repellents, attractants, pheromones, feeding stimulants or other biologically active compounds all of which can be added to the pollen to form a multi-component composition giving an even broader spectrum of agricultural protection.

In some embodiments, the pollen can be combined with appropriate solvents or surfactants to form a formulation. Formulations enable the uniform distribution of a relatively small amount of the pollen over a comparatively large growth area. In addition to providing the user with a form of a pollen that is easy to handle, formulating can enhance its fertilization activity, improve its ability to be applied to a plant, enable the combination of aqueous-soluble and organic-soluble compounds, improve its shelf-life, and protect it from adverse environmental conditions while in storage or transit.

Numerous formulations are known in the art and include, but are not limited to, solutions, soluble powders, emulsifiable concentrates, wettable powders, liquid flowables, and dry flowables. Formulations vary according to the solubility of the active or additional formulation ingredients in water, oil and organic solvents, and the manner the formulation is applied (i.e., dispersed in a carrier, such as water, or applied as a dry formulation).

Hence, contemplated are wet (e.g., liquid) as well as dry formulations.

WO2020/084586 describes pollen formulations for weed control and is hereby incorporated by reference in its entirety.

According to a specific embodiment, applying the ACCase inhibitor is effected prior to the artificially pollinating.

According to a specific embodiment, the applying the ACCase inhibitor is effected 3-60 days (d), e.g., 14-30 d, days prior to the artificially pollinating (e.g., 10-60 d, 10-50 d, 10-40 d, 10-30 d, 10-20 d, 14-30 d, 3-14 d, 3-7 d, 3-10 d, 3-14 d, 7-14 d, 7-10 d).

According to a specific embodiment, the applying the ACCase inhibitor is effected concomitantly with the artificially pollinating.

According to a specific embodiment, the ACCase inhibitor and pollen for the artificially pollinating are in a co-formulation.

According to a specific embodiment, the ACCase inhibitor and pollen for the artificially pollinating are in separate formulations.

According to a specific embodiment, the applying the ACCase inhibitor is effected prior to and concomitantly with the artificially pollinating.

According to a specific embodiment, a regimen for the applying comprises applying the ACCase inhibitor at least once is effected (e.g., up to 60 days), as above, prior to the artificially pollinating followed by concomitant treatment with the ACCase inhibitor and the artificially pollinating and optionally followed by artificially pollinating with or without the applying the ACCase inhibitor.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLES

### Example 1

### Exp 254

### Materials and Method

### Plants Cultivation

The experiment was conducted during April-May 2021 in a net house in Rehovot, Israel. A. palmeri plants were sown in germinating trays. Three weeks after the seedlings had emerged, the male plants were transplanted in the net house. A. palmeri plants were divided into 10 groups of 10 plants, 100 male plants in total. In addition, 30 females, 3 females per treatment, were transplanted in 4 L pots with a potting soil mixture and were grown in a different net house, isolated from male pollen.

### Pollen Collection

Once the male plants had all started to flower, the pollen had been collected daily with a vacuum cleaner. The vacuum cleaner had been mounted with a replaceable filter located ahead of the dust container, thus catching the pollen before it enters the container and improving its collection. A new filter was used for each group, and the filters were kept in a 50 ml tube before the pollen was extracted and weighed in the lab.

### Male Sterilant Agents

The experiment tested 8 male sterilant agents (Table 2): (1) Triton X-100 (Adama), at label rate, ˜8 times the rate used in experiment I; (2) Tribenuron-Methyl (TBM) (Gadot), 1/100 the rate used in experiment I; (3) 10% Paraffin oil (Life—Superpharm) diluted in Silicon oil 2 cST; (4) E.O.S. (Adama), an insecticide with a physical mode of action, based on petroleum oil; (5) Maleic Hydrazide (Sigma), an Auxin (plant hormone) disruptor known to affect pollen production; (6) Pyrithiobac (IHARA chemical industry co. ltd), an herbicide of the AHAS inhibitors group, regularly used in cotton cultivation to control broadleaf weeds; (7) Diuron (Adama), a herbicide of the Photosystem II inhibitors, regularly used in cotton cultivation; (8) Clethodim (Select Super™ a selective herbicide used to control Gramineae. Another group of plants were treated with water only as control, and another was not treated at all (Blank). The concentrations are shown in Table 2 below.

### Treatment

The treatments were applied using a hand-held sprayer, the females were sprayed first and then the males. ˜650 ml solution was used per treatment for both males and females, except the Paraffin:Silicon oil treatment in which 500 ml was used. The solutions were sprayed on top of the plants except the Diuron that was sprayed directly to the soil and stem, except for one female that was sprayed on top. To activate the Diuron, each plant was watered with 1 L of water.

### Pollination

The experiment aimed to test not just the male sterility properties of the agents but also to examine the effect on the seed set. To do so, one week after treatment, the main inflorescence of each female (except the blank) was pollinated with fresh pollen mixed with talc in 2:1 ratio using a puffer. 70 mg of pollen was applied on each female. Two weeks after pollination the inflorescences were harvested, dried, thrashed and the seeds were counted.

TABLE 2
Chemical agents and their concentrations

| Agent | Concentration | |
|---|---|---|
| 1 Triton X-100 | 0.025% | |
| 2 Tribenuron-Methyl | 0.004 | mg/L |
| (TBM) | (1/25,000 label rate) | |
| 3 10% Paraffin in 2 cST | Pure, 20 ml/plant | |
| 4 E.O.S | 1% | |
| 5 Maleic Hydrazide (MH) | 50 | ppm |
| 6 Pyrithiobac (Staple) | 5.4 | μL/L |
| | (1/100 label rate) | |
| 7 Diuron | 5 | ml/L |
| 8 Clethodim | 3.5 | ml/L |

(Select Super(TM) )

### Results

### Pollen Production

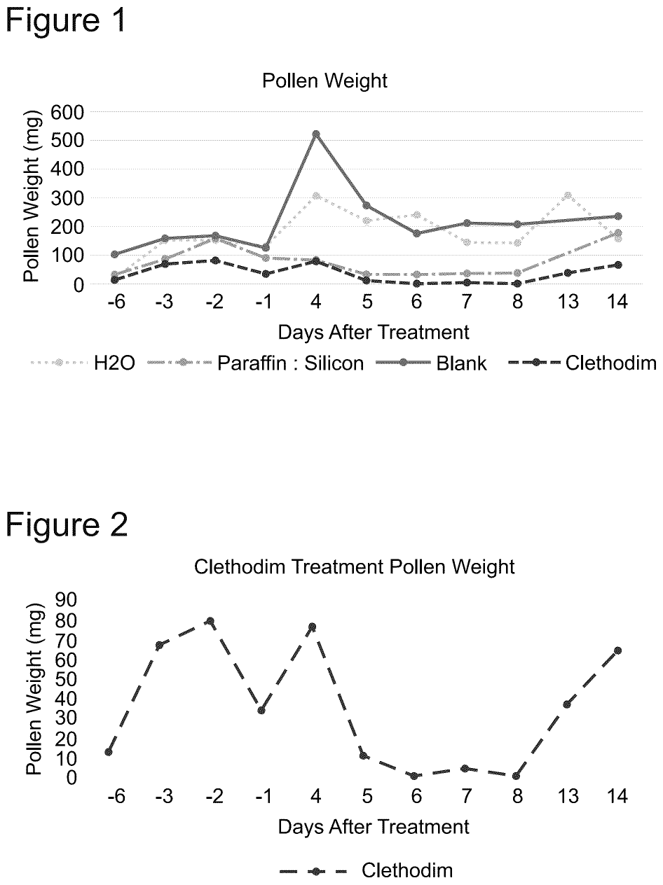

The Paraffin:Silicon oil and Clethodim treatments caused a major reduction in pollen production with no apparent injury to the plants (FIG. 1). Furthermore, the effect initiated 5 days after treatment, and for the Paraffin:Silicon oil it seemed to be transient as it leveled back with the blank after 2 weeks. Although the Clethodim group had low amounts of pollen to begin with, the treatment reduced the pollen weight to 1/10 of the lowest amount collected before treatment and even to below detection levels (FIG. 2). After 14 days the Clethodim group got back to the weight it had before the treatment and the effect seemed to alleviate.

It is important to stress that the Clethodim treatment had no visible effect on the plants, and the Paraffin:Silicon oil had an oily appearance for the first 4 days.

### Seed Set

Only A. palmeri females that had been treated with agents that showed promising results in male sterility induction were further examined. However, the phytotoxicity of the agents was examined in all females to rule out agents that had caused injuries. The Diuron killed all three females, and the Pyrithiobac caused chlorosis and growth stunt. The rest of the treatments had no effect.

The seed set of the Paraffin:Silicon and Clethodim was examined and compared to the blank and H₂O. The Paraffin:Silicon and Clethodim reduced the number of seeds per inflorescence mg having about 50% and 70% of the water treatment value, respectively. The Paraffin:Silicon increased the abortion rate while the Clethodim had no effect, when compared to the water.

TABLE 3
The average number of seeds by treatment.
The values are the average of 3 inflorescences (Inflo.) each
from a different female. Normal seeds, aborted seeds (i.e., non-
germinating seed (and total seeds values are in number of seeds.
Abortion rate is the fraction of aborted seeds from the total
seed number. Seeds/ mg inflo. is the fraction of the
total seed number divided by inflorescence weight.

| | Average | | | | | |
|---|---|---|---|---|---|---|
| | Inflo. | | | | | Seeds/ |
| | Weight | Normal | Aborted | Total | Abortion | mg |
| Treatment | (mg) | Seeds | Seeds | Seeds | Rate | inflo. |
| Blank | 880.3 | 10.3 | 11 | 21.3 | 0.43 | 0.03 |
| H2O | 1376.3 | 890.7 | 277.7 | 1168.0 | 0.24 | 1.09 |
| Par:Sil | 543.0 | 166.3 | 135.3 | 301.7 | 0.44 | 0.58 |
| Clethodim | 667.3 | 349 | 80.7 | 429.7 | 0.17 | 0.78 |

### Example 2

### Exp 275

### Materials and Methods

### Male Plants Cultivation

The experiment was conducted during May-June 2021 in a net house in Rehovot, Israel. A. palmeri plants were sown in the net house soil and were grown for over a month before the experiment started. A. palmeri plants were divided into 6 groups of 10 plants, 60 male plants in total.

### Pollen Collection

The plants were mature and produced pollen when the experiment started. The pollen had been collected daily with a vacuum cleaner. The vacuum cleaner had been mounted with a replaceable filter located ahead of the dust container, thus catching the pollen before it enters the container and improving its collection. Pollen was collected for 5 days before the treatment and was continued for 2 weeks afterwards.

### Male Sterilant Agents

The experiment tested 5 male sterilant agents: (I) Silicon oil 2 cST; (II) 2% Paraffin oil (Life—Superpharm) in Silicon oil 2 c/st; (III) 10% Paraffin oil (Life—Superpharm) in Silicon oil 2 cST; (IV) Clethodim (Select Super™), same as in Example 1; (V) Pyrithiobac, at 1/10 the concentration used in experiment II. Another group of plants was not treated at all (Blank).

### Treatment

The treatments were applied using a hand-held sprayer. The solutions were sprayed on top of the plants.

### Results

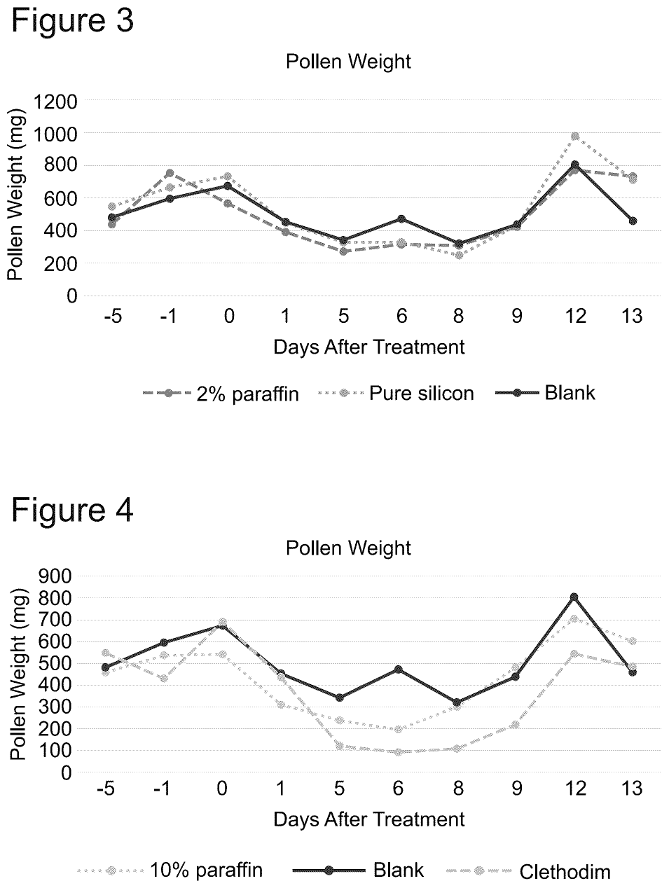

The pure silicon oil 2 cST and the 2% paraffin oil treatments did not have an effect on the pollen weight. As can be seen in FIG. 3 both treatments had the same daily pollen weight as the blank.

On the other hand, the 10% paraffin oil and the Clethodim treatments did have an effect of the pollen weight and reduced it for 8 days (FIG. 4). The reduction in pollen weight initiated on the first day or 5 days after the application of 10% Paraffin oil or Clethodim, respectively. The Clethodim had a major effect on the pollen weight, having fifth of the blank pollen weight 6 days after treatment. Both treatments showed a recovery in pollen production and leveled back to the blank weight. The Clethodim did not cause any apparent damage to the plants and the 10% Paraffin oil did make the plants oily for 3 days.

### Example 3

### Exp 289

The goal of this experiment was to examine the effects of Clethodim (Select Super™) on seed set in A. palmeri female plants. The results of Example 1 provided an initial indication on a reduction in seed set one week after an application of Clethodim. The following experiment tested the effect of Clethodim on seed set when pollination occurs from 1.5 hours to 10 days after treatment with Clethodim.

### Materials and Method

### Female Plants Cultivation

The experiment was conducted during June-July 2021 at the tests farm of the Tests farm of the Faculty of Agriculture, Rehovot, Israel, Israel. A. palmeri plants were sown in germinating trays. Three weeks after the seedlings had emerged, they were transplanted to 4 L pots with a potting soil mixture. The female plants were separated from the male plants and were grown outside in a location isolated from air-borne pollen. Upon maturation, 6 female plants were selected and divided into 2 groups of 3 plants.

### Treatments

Spraying of the entire plants with either tap water or Select Super™ (3.5 ml/1) using a hand-held 1.5 L sprayer, with enough distance between the groups to prevent contamination.

### Pollination

To test the effect of Clethodim on seed set, the inflorescence of the plants were artificially pollinated. On each time interval, a paper tube with 10 mg of fresh non-irradiated pollen was carefully placed on an inflorescence, leaving it for 20 minutes before removing. On each time interval 2 inflorescences of each plant were pollinated, a total of 6 inflorescence from 3 females per group. The intervals were as follows: 1.5 hour, 1 day, 2 days, 4 days, 7 days and 10 days after treatment.

### Results

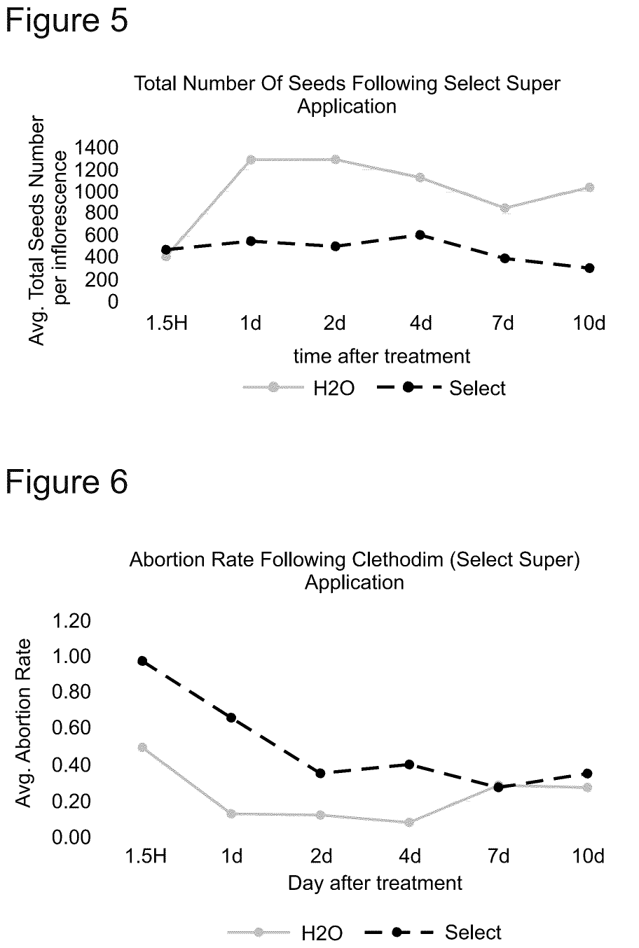

The results showed that after 1.5 h both treatments had a relatively low seed number (FIG. 5) and an increase in abortion rate (FIG. 6), which indicates that the aqueous application alone is enough to interrupt the fertilization process. After 1 day the total seed number of the water treatment increased significantly, a decrease occurred after 7 days, but other than that the level was high (above 1000 seeds per inflorescence). On the other hand, the total seed number of the Clethodim (Select Super™) treatment, remained low till the end of the experiment.

After 1 day the abortion rate of the water treatment returned to the expected levels without much change except for day 7 and day 10 which showed an increase in the abortion rate. That could be due to short water stresses the plants had experienced during the last part of the experiment. The abortion rate of the Clethodim (Select Super™ treatment) had decreased too over time but the levels were significantly higher compared to the water control, Nonetheless, it took 7 days in total for the Clethodim (Select Super™) abortion rate to return to the same level as the water treatment.

To conclude, the results show that the application of Clethodim (Select Super™) interferes with pollination, resulting in decreased total seed number for at least 10 days, and increased abortion rate for up to 7 days after application.

### Example 4

### Exp 313

The goal of this experiment was to examine dose response of Clethodim (Select Super™) treatment and validate the results of Example 3.

### Materials and Method

### Female Plants Cultivation

The experiment was conducted during September 2021 at the tests farm of the Faculty of Agriculture in Rehovot, Israel. A. palmeri plants were sown in germinating trays. 3 weeks after the seedlings had emerged, they were transplanted to 4 L pots with a potting soil mixture. The female plants were separated from the male plants and were grown outside in a location isolated from air-borne pollen. Upon maturation, 9 female plants were selected and divided into 3 groups of 3 plants.

### Treatments

The experiment tested 2 rates of Select Super™ (Clethodim 120 gr/L-Arysta): (I) Low rate (3.5 ml/1), (II) High rate (7 ml/1). Another group of plants was treated with tap water (Control), [3.5 ml/L treatment=0.42 gr/L in active ingredient, 7 ml/L treatment=0.84 gr/L].

Treatment procedure was conducted as follows: spraying of the entire plants with the different treatments using a hand-held 1.5 L sprayer, with enough distance between the groups to prevent contamination.

### Pollination

To test the effect of Clethodim on seed set, artificial pollinations were conducted in several time intervals following clethodim treatment. On each time interval, 2 inflorescences on each plant were artificially pollinated by placing a paper tube with 10 mg of fresh non-irradiated pollen on the inflorescence and leaving it for 20 minutes before removing. On each time interval a total of 6 inflorescences from 3 female plants were pollinated. The intervals were as follows: 1.5-hour, 1 day, 2 days, 4 days, 7 days, 10 days and 22 days after treatment.

### Results

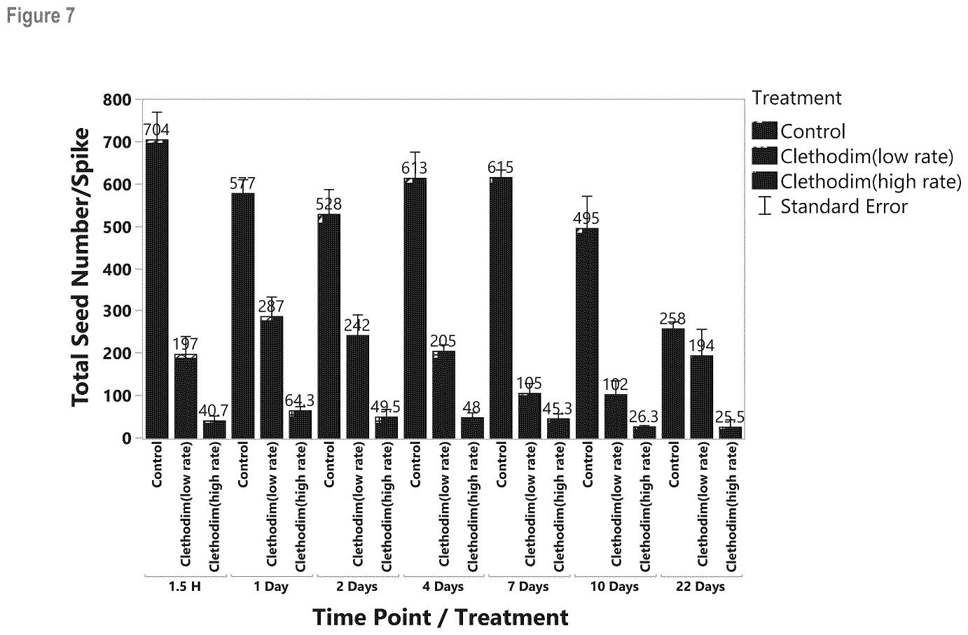

The results showed that from the first time point (1.5 hour) there is a strong reduction in the number of seeds produced following Clethodim (Select Super™) application in both the low and high-rate treatments, the reduction is stronger in the high dose (FIG. 7). At the time interval of 22 days, with the low rate Clethodim, the total seed number returned almost to the same level as the control. In contrast, in that time point (22 days) in the high rate Clethodim group, the total seed number remained low. It's important to stress that the both rates of Clethodim treatment had no visible effect on the plants but only on seed number.

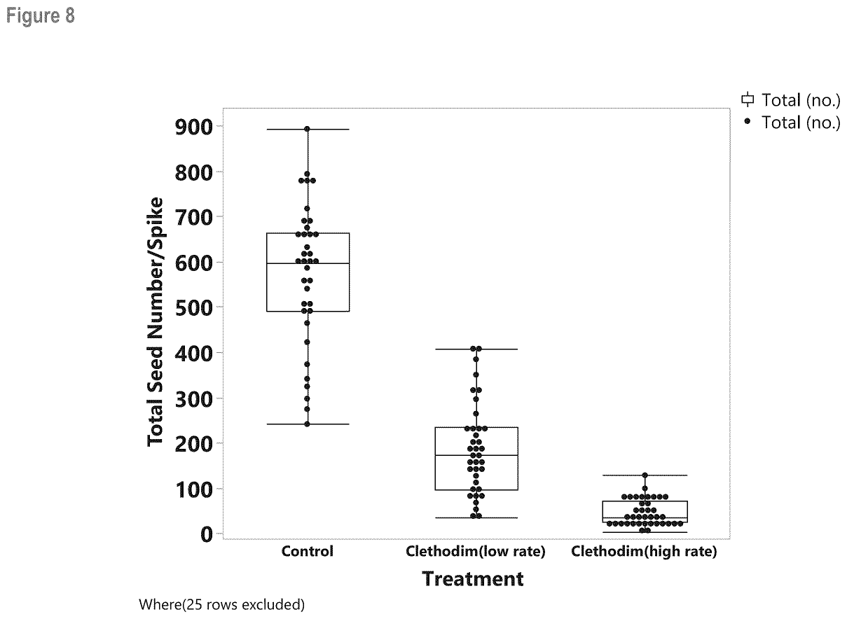

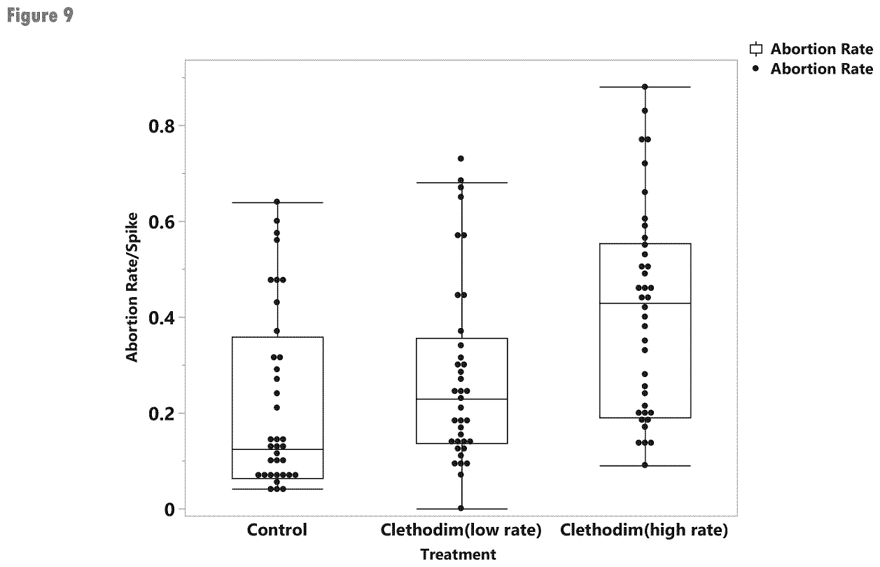

The low rate and the high rate of Clethodim reduced, on average, the number of seeds produced by 67% and 92% in comparison to the control treatment value, respectively. It is clearly demonstrated that a dose effect is also evident when all time points are averaged together (FIG. 8). In addition, there was a dose dependent increase in abortion rate as well (FIG. 9).

### Example 5

### Exp 343 Part 1

### Clethodim has a Sterilant Effect on Females in Various Commercial Formulations

The goal of the experiment was to examine the effects of different formulations of clethodim on the seed set in A. palmeri female plants.

### Materials and Method

### Plants Cultivation

The experiment was conducted during November-December 2021 at the tests farm of the Faculty of Agriculture, Rehovot, Israel, in a heated green house.

A. palmeri plants were sown in germinating trays. 3 weeks after the seedlings had emerged, they were transplanted to 6 L pots with a potting soil mixture. The female plants were divided into 3 groups of 4 plants each. The plants were grown in a location isolated from air-borne pollen.

### Different Clethodim Formulations

The experiment tested 2 different types of clethodim formulations: (1) Select Super™ (Arysta Lifescience), 116 gr/L clethodim, rate of 0.7 ml/L (0.81 gr/L) (2) Arrow Super™ (Adama), 120 gr/L clethodim, rate of 0.7 ml/L (0.84 gr/L). Another group of plants was treated with tap water and served as control.

### Treatment

Treatment procedure was conducted as follows: spraying of entire plants using a hand-held 1.5 L sprayer for a full cover of all plant parts. Each group of plants was sprayed with the tested formulation while keeping enough distance between the groups to prevent contamination.

### Pollination

To test the effect of the chemical agent on seed set, artificial pollinations were conducted in several time intervals following the treatment. On each time interval, 1 spike from each plant was artificially pollinated by placing a paper tube with 10 mg of fresh non-irradiated pollen on the spike and leaving it for 20 minutes before removing. On each time interval a total of 4 spikes from 4 female plants were pollinated. The intervals were as follows: 4 days, 7 days, 14 days and 21 days.

### Seed Extraction

Treated spikes were cut and dried following which all seeds were extracted manually. The total number of seeds formed per spike was counted and recorded.

### Results

Data analysis was based on total seed number per spike and the graph is presenting the average value per treatment.

### Results

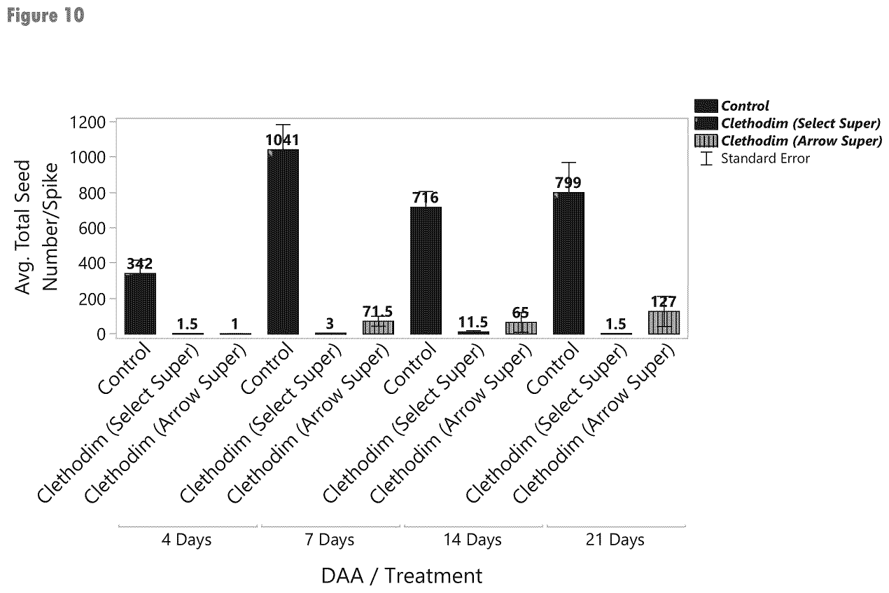

Both commercial clethodim based products, Select Super™ and Arrow Super™, had a strong effect as a sterilant and showed a significant reduction in total seed number at all the tested time points (see FIG. 10). Clearly both treatments are effective albeit with different kinetics.

### Example 6

### Exp 343 Part 2

### Female Sterility Effect of the ACCase Inhibitors: FOPS, DIMS

The goal of this experiment was to test the ability of other members of the ACCase family to act as sterilants on A. palmeri female plants.

### Materials and Methods

The experiment was conducted during November-December 2021 at the tests farm of the Faculty of Agriculture, Rehovot, Israel, in a heated green house.

A. palmeri plants were sown in germinating trays. Three weeks after the seedlings had emerged, they were transplanted to 6 L pots with a potting soil mixture. The female plants were divided into 4 groups of 4 plants, 16 plants in total. The plants were grown in a location isolated from air-borne pollen.

The experiment tested 4 female sterilant agents (see Table 4 below): (1) clethodim (Select Super™, Arysta Lifescience) a selective herbicide used to control Gramineae from cyclohexanedione (Dim) family, (2) Haloxyfop (Gallant Super, Dow) a selective herbicide used to control Gramineae from aryloxyphenoxy (FOP) family, (3) Quizalofop (Pantera, Chemark Kft) a selective herbicide used to control Gramineae from aryloxyphenoxy (FOP's) family. Another group of plants was treated with tap water and served as a control.

TABLE 4
Chemical agents and their rate:

| # | Herbicide | Rate |
|---|---|---|
| 1 | Clethodim (Select Super(TM) ) | 7 ml/L |
| 2 | Haloxyfop (Gallant Super) | 7.5 ml/L |
| 3 | Quizalofop (Pantera) | 7.5 ml/L |

### Treatment:

Treatment procedure was conducted as follows: spraying of the entire plants using a hand-held 1.5 L sprayer for a full cover of all plant parts. Each group of plants was sprayed with the tested treatment while keeping enough distance between the groups to prevent contamination.

### Pollination

To test the effect of the chemical agent on seed set, artificial pollinations were conducted in several time intervals following the treatment. On each time interval, 1 spike from each plant was artificially pollinated by placing a paper tube with 10 mg of fresh non-irradiated pollen on the spike and leaving it for 20 minutes before removing. On each time interval a total of 4 spikes from 4 female plants were pollinated. The intervals were as follows: 14 days and 21 days.

### Seed Extraction

Treated spikes were cut and dried following which all seeds were extracted manually. The total number of seeds formed per spike was counted and recorded.

Statistical analysis was based on total seed number per spike and the graph is presenting the average value for each treatment.

### Results

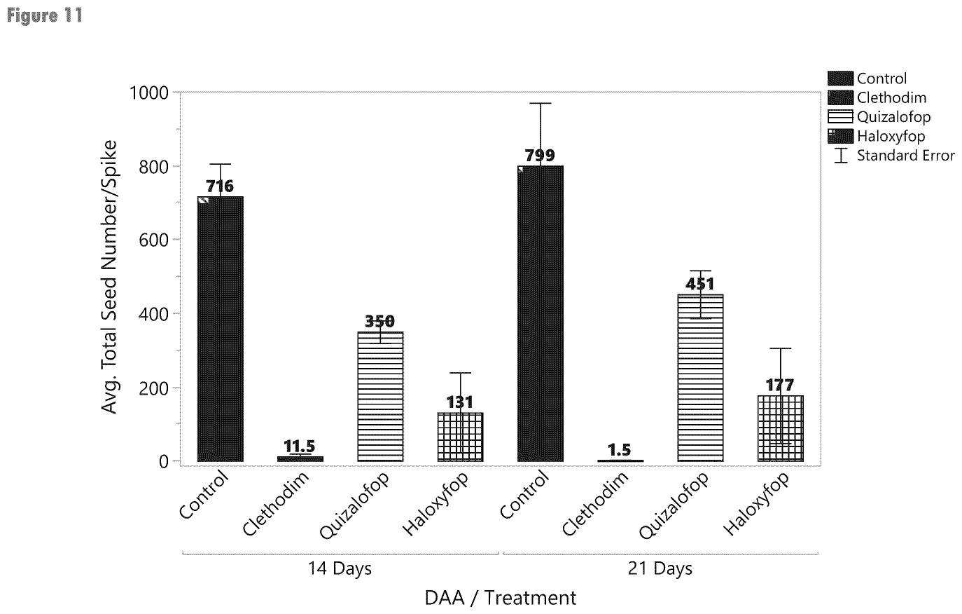

Clethodim application led to the strongest reduction in the average total seed number in all the tested time points but clear reduction in seed number was obtained following the applications of all the tested active ingredients (see FIG. 11).

### Example 7

### EXP420

### Female Sterility Effect of the ACCase Inhibitors of the FOP Family

The goal of this experiment was to further screen additional chemical agents from the ACCase family as a potential sterilant agents and to reduce the seed set in A. palmeri female plants.

### Materials and Methods

### Plants Cultivation

The experiment was conducted during May-June 2022 at the tests farm of the Faculty of Agriculture, Rehovot, Israel.

A. palmeri plants were sown in germinating trays. Three weeks after the seedlings had emerged, they were transplanted to 6 L pots with potting soil mixture. The female plants were separated from the male plants and were grown outside in a location isolated from air-borne pollen. Upon maturation, 9 female plants were selected and divided into 3 groups of 3 plants each.

The experiment tested 2 female sterilant agents (1) Clethodim (Select Super™, Arysta Lifescience) a selective herbicide used to control Gramineae from cyclohexanedione (Dim's) family in 0.7% rate, (2) Fluazifop-p-botyl (Deganol, Syngenta) a selective herbicide used to control Gramineae from aryloxyphenoxy (FOP) family in 0.7% rate. Another group of plants was no not treated at all and served as control.

### Treatment:

Treatment procedure was conducted as follows: spraying of the entire plants using a hand-held 1.5 L sprayer for a full cover of all plant parts. Each group of plants was sprayed with the tested treatment while keeping enough distance between the groups to prevent contamination.

### Pollination

To test the effect of the chemical agent on seed set, artificial pollinations were conducted in several time intervals following the treatment. On each time interval, 2 spikes from each plant were artificially pollinated. The artificial pollination procedure was conducted as follows—placing a paper tube with 10 mg of fresh non-irradiated pollen on the spike and leaving it for 20 minutes before removing. On each time interval a total of 6 spikes from 3 female plants were pollinated. The intervals were 7 days and 14 days.

### Seed Extraction

Treated spikes were cut and dried following which all seeds were extracted using an air-column, separating normal seeds from debris and aborted seeds. The weight of all normal seeds per spike was measured and recorded.

### Results

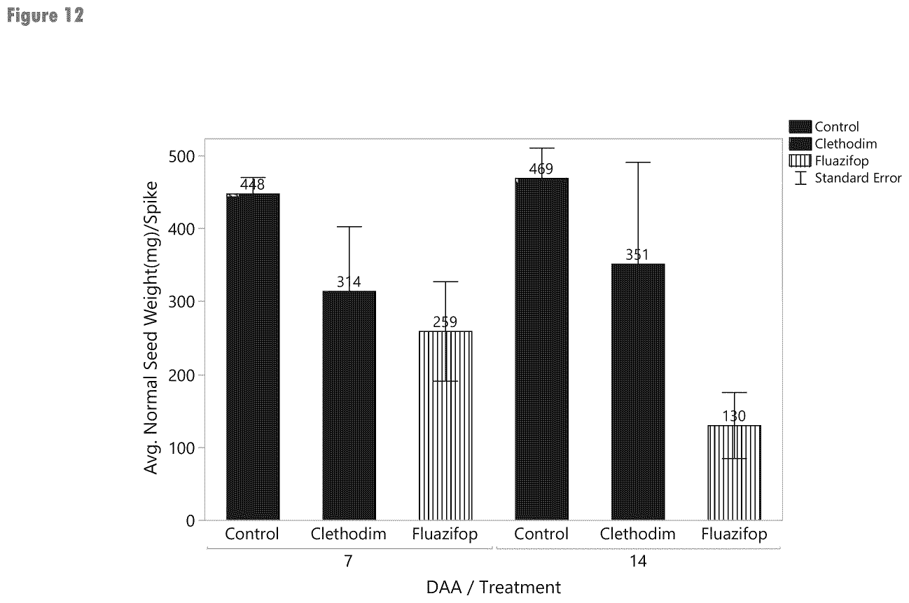

Clethodim (Select Super™, Arysta Lifescience) and Fluazifop-p-botyl (Deganol, Syngenta) applications resulted in a reduction in the average normal seed weight for at least 14 days (FIG. 12).

### Example 8

### Exp 321

### Male Sterility Agents Screening #2

The goal of this experiments was to repeat results with Select Super™ (Arysta Lifescience) and test an additional formulation of clethodim to act as a sterilant on A. palmeri male plants.

### Materials and Methods

### Plants Cultivation

The experiment was conducted during September-October 2022 in a net house in Rehovot, Israel. A. palmeri plants were sown in germinating trays, 3 weeks after the seedlings had emerged, the male plants were transplanted in the net house. A. palmeri plants were divided into 4 groups of 10 plants each, 40 male plants in total.

### Pollen Collection

Once the male plants had all started to flower, the pollen had been collected daily with a vacuum cleaner in the same manner as described in Example 1. Pollen was collected in specific days following the applications up to 12 DAA.

### Male Sterilant Agents

The experiment tested 2 male sterilant agents: (1) Clethodim (Select Super™, Arysta Lifescience) low rate: 3.5 ml/L and high rate: 7 ml/L, (2) Clethodim (Arrow Super™, Adama) 7 ml/L. Another group of plants were not treated at all and served as a control.

### Treatment

Treatment procedure was conducted as follows: spraying of the entire plants using a hand-held 1.5 L sprayer for a full cover of all plant parts. Each group of plants was sprayed with the tested treatment while keeping enough distance between the groups to prevent contamination.

### Results

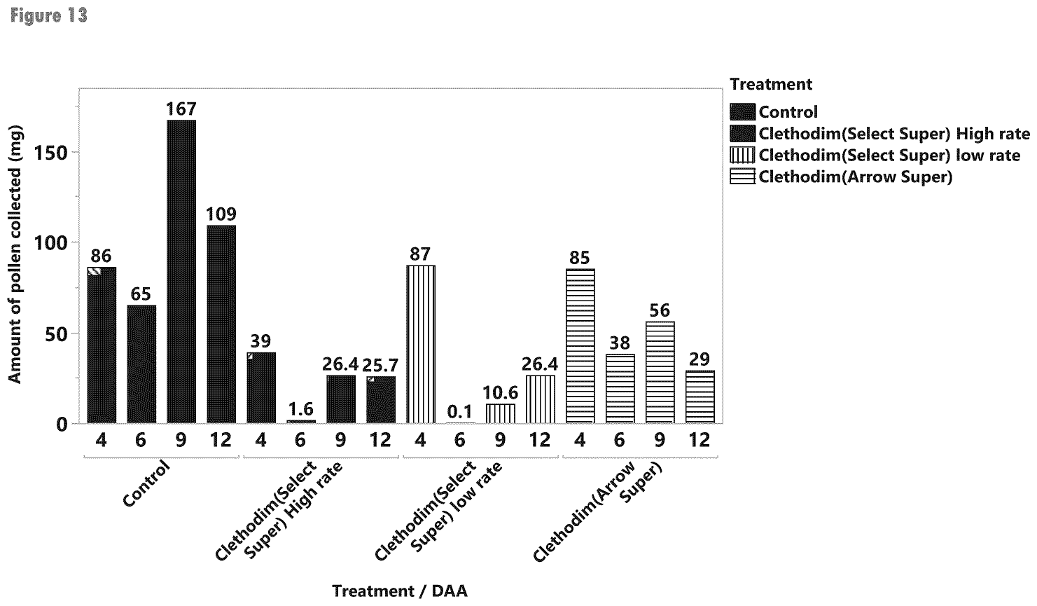

The clethodim (Select Super™) in both rates and clethodim (Arrow Super™) treatments caused a serious reduction in pollen production (FIG. 13).

The clethodim (Arrow Super™) and clethodim (Select Super™) high rate reduced the pollen production between day 4 and the end of the experiment by 51% and 78%, respectively.

### Example 9

### Exp 401

### Effect of Clethodim on a Broadleaf Panel of Plant Species

The goal of this experiment was to examine if ACCase inhibitors can function as a sterilant on other broadleaf families.

### Materials and Method

### Plants Cultivation

The experiment was conducted during April-June 2022 at the test farm of the Faculty of Agriculture in Rehovot, Israel. The different broad leaf species (Table 5) were sown in germination trays. 3-4 weeks after the seedling had emerged, they were transplanted in 4 L pots with potting soil mixture. Amaranthus tuberculatus female plants were separated from male plants and grown outside in a location isolated from air borne pollen. Upon maturation, 10 plants from each species, except for A. tuberculatus females, were selected and divided into 2 groups (control and treatment). In A. tuberculatus, 8 female plants were used for the testing.

TABLE 5
Broadleaf species included in the experiment:

| # | Specie |
|---|---|
| 1 | Abutilon theophrasti |
| 2 | Solanum nigrum |
| 3 | Conyza bonariensis |
| 4 | Amaranthus tuberculatus |

### Treatments

All the treated plants were sprayed with clethodim (Select Super™, Arysta Lifescience) in 7 ml/L rate while the control group was treated with tap water.

Treatment procedure was conducted as follows: spraying of the entire plants with the different treatments using electric back sprayer for a full cover, with enough distance between the groups to prevent contamination.

Pollination of Amaranthus tuberculatus

To test the effect of treatment on the seed set, artificial pollinations were conducted 7 days following the clethodim treatment. One spike from each plant was artificially pollinated by placing a paper tube with 10 mg of fresh non-irradiated pollen on the spike and leaving it for 20 minutes before removing. A total of 4 spikes from 4 female plants were pollinated.

### Results

Four, 7 14 and 21 days after treatment, the plants were visually examined carefully to identify possible sterilant effects such as reduction in pollen production, growth delay, damaged flowers, loss of flowers, loss of pods and phytotoxicity. These effects were measured or evaluated and recorded. The average values of each parameter were calculated both for the treated and for the control groups and a statistical analysis was conducted.

In all species, Abutilon theophrasti, Solanum nigrum, Conyza bonariensis and Amaranthus tuberculatus a clear negative impact was detected related to their reproductive organs.

Amaranthus tuberculatus Seed Set

Clethodim application reduced the average seed weight per spike strongly, demonstrating a reduction of 93% in comparison to the control spikes (see Table 6). Clethodim treatment had no visible effect on the plants other than on the flowering organs.

TABLE 6
The average weight of seeds per spike by treatment:

| | Average total seed |
|---|---|
| Treatment | weight per spike (mg) |
| Blank | 5 |
| Control | 197.25 |
| Clethodim | 13.25 |
| (Select Super(TM) ) | |

Amaranthus tuberculatus Pollen Production

The plants were visually examined carefully, and a clear difference was detected in the pollen structure on the spike and pollen shedding between the clethodim treated plants group and the control plants. The treated spikes did not produce wind-dispersed pollen grains at all, in addition a visual phenotype that demonstrated a joint anther instead of a regular, separated, anther was detected (See FIG. 18). The effect initiated 4 days after treatment and remained for at least 21 days.

Abutilon theophrasti

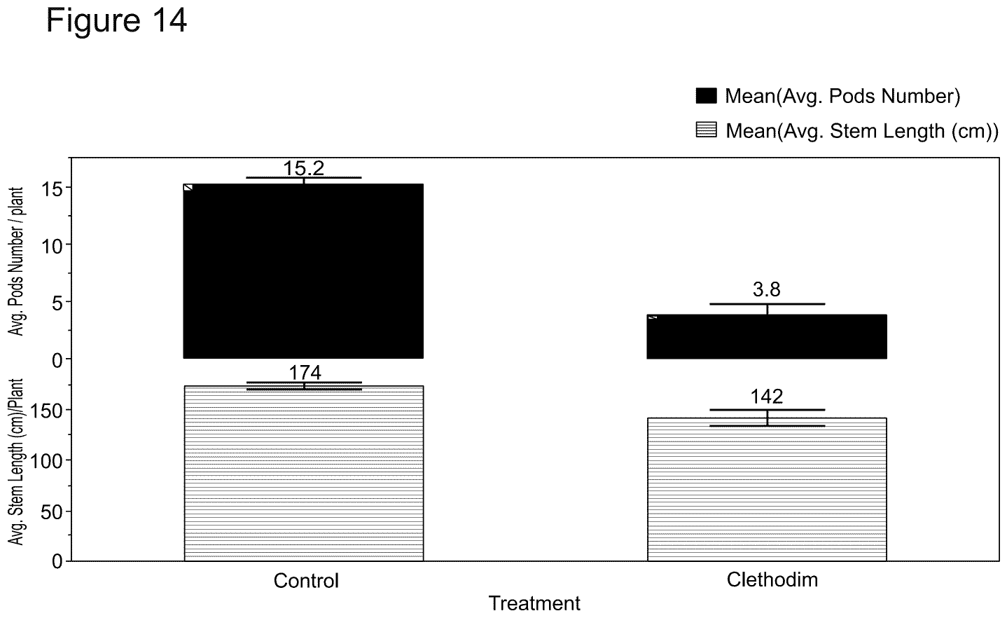

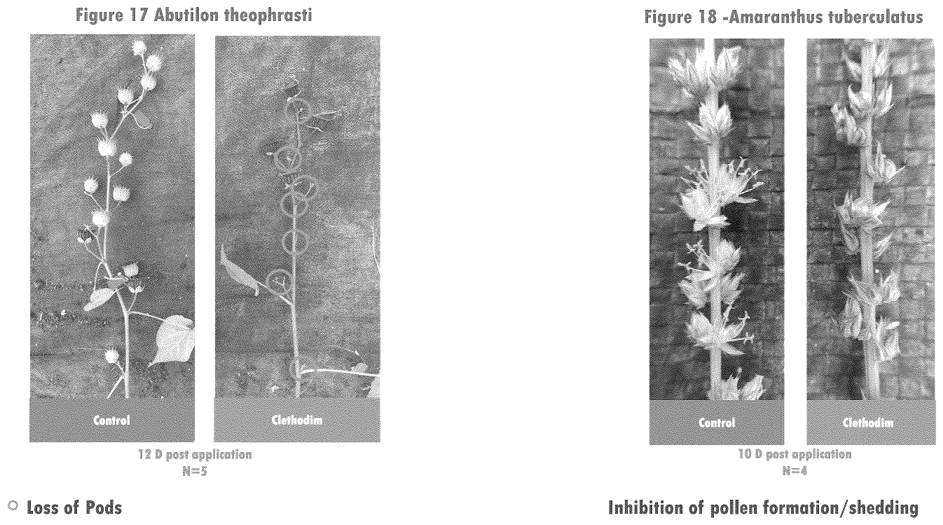

Following 7 days from the clethodim application, plants started to suffer from Blossom—Drop. The results show that 15 days after application (DAA) the average pods number was reduced by 75% with a p-value of *0.0001 in comparison to the control treatment (see FIG. 14 and FIG. 17). In addition, 15 DAA there was a delay in the growth of the main stem, resulting in 19% reduction in average stem length with p-value of *0.0058.

Solanum nigrum

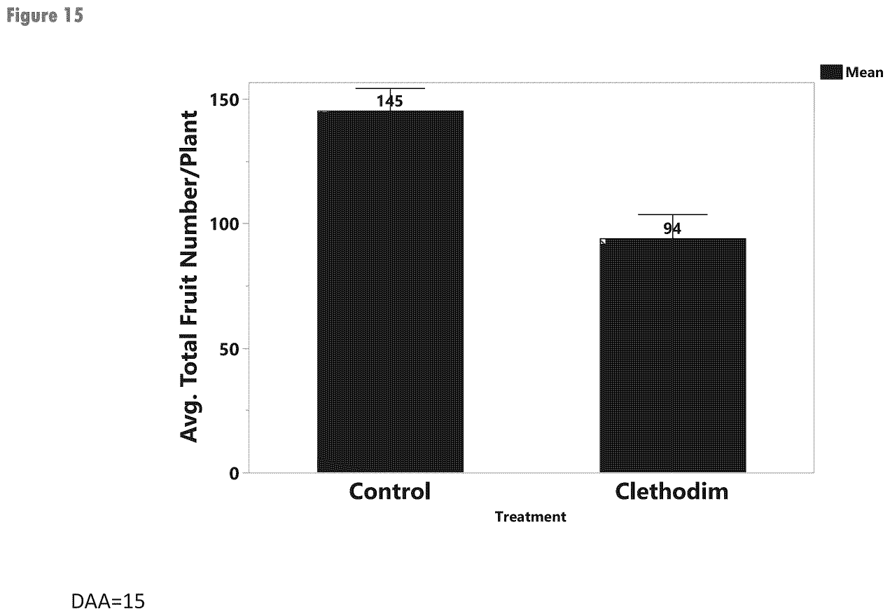

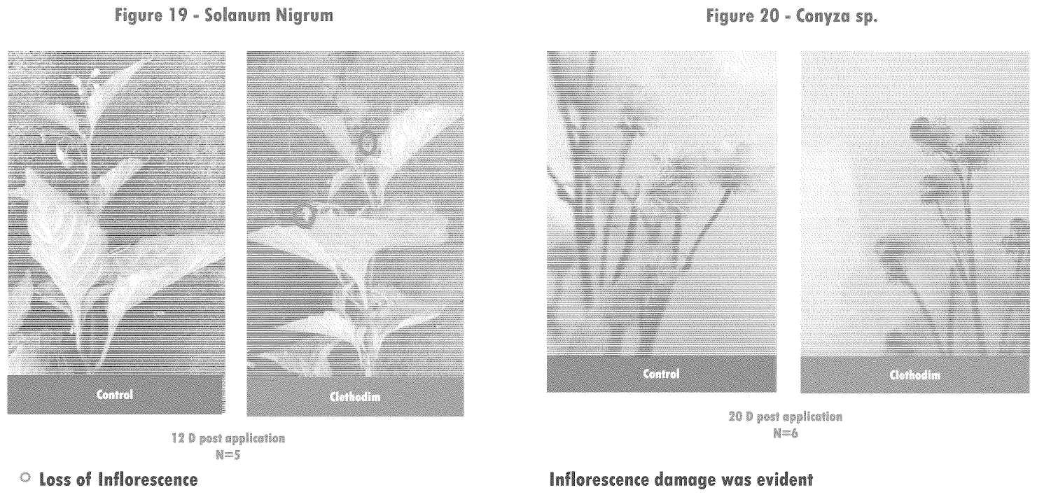

Observation from 7 DAA already indicated on inflorescences and young fruit drop as a result of the clethodim treatment. 15 DAA the average total fruit number was calculated both for the treated and for the control groups and demonstrated a reduction of 35% in the clethodim treated group with a p-value of 0.0048 (see FIG. 15 and FIG. 19).

Conyza bonariensis

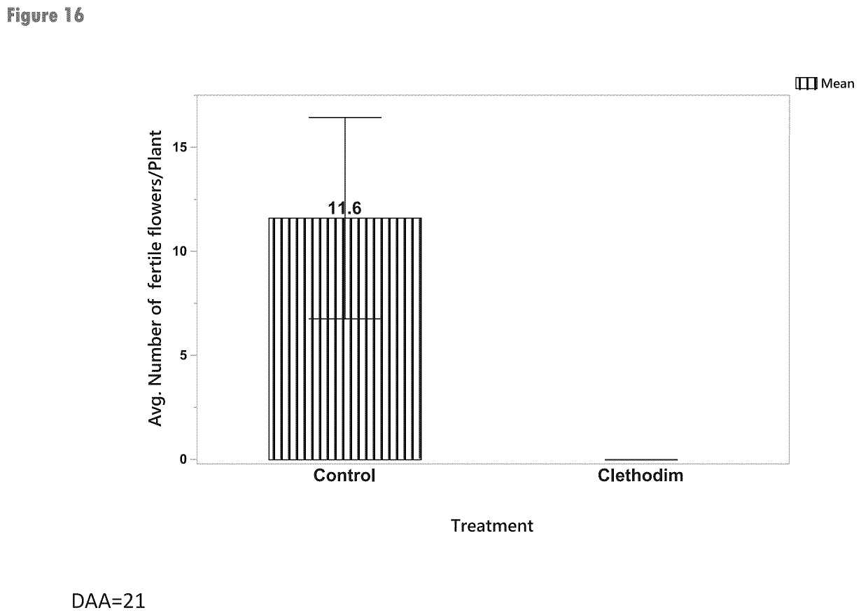

The clethodim application damaged existing inflorescences and delayed formation of new flowers. Twenty one DAA the average number of fertile flowers (flower that contains the cypsela, a linear shaped seed covered win hairs) was reduced from 11.6 flowers per plant in the control to no fertile flowers at all in the clethodim treated plants (FIG. 16 and FIG. 20).

To conclude, the results show that application of clethodim not only affects Amaranthus palmeri species, but also inhibits the reproduction of various broadleaf weeds from a diversified set of weed families.

### Example 10

### Exp 455

### Effect of Clethodim Application Timing on Seed Formation

The goal of the experiment was to examine different application timings of clethodim at various palmer amaranth growth stages to determine the most affective time point for clethodim application to reduce the seed set in A. palmeri female plants.

### Materials and Method

### Plants Cultivation

The experiment was conducted during July-September 2022 at the tests farm of the Faculty of Agriculture, Rehovot, Israel. A. palmeri plants were sown in germinating trays. Ten days after the seedlings had emerged, they were transplanted to 8 L pots with potting soil mixture. Female plants were separated from male plants as soon as the gender was visual. The plants were grown outside in a location isolated from air borne pollen.

During plant growth, the female plants were divided into five groups according to different developmental stages and clethodim was applied accordingly at the specified time points:
1. Seedlings (approx. 4-7 leaves)—7 days after planting (DAP).
2. Young vegetative plants—14 DAP.
3. Mature vegetative plants with induction of flowering—21 DAP.
4. Short main with no lateral inflorescence—26 DAP.
5. Developed main with small-medium lateral inflorescences 33—DAP.

### Treatment:

In each time point the treated plants were sprayed with clethodim (Select Super™, Arysta Lifescience 10 ml/L rate). Another group of plants was not treated at all and served as control.

Treatment procedure was conducted as follows: spraying of entire plants using a motor back sprayer for a full cover of all plant parts. Each group of plants was sprayed while keeping enough distance between the groups to prevent contamination.

### Pollination

To test the effect of the clethodim on seed set, artificial pollinations were conducted following the treatment. 2 spikes from each plant were artificially pollinated by placing a paper tube with 10 mg of fresh pollen on the spike and leaving it for 20 minutes before removing. The pollination was conducted at 40 DAP for all groups.

### Seed Extraction

Treated spikes were cut and dried following which all seeds were extracted and an air-column was used to separate normal seeds from debris and aborted seeds. The total normal seeds weight per spike was measured and recorded.

Data analysis was based on normal seed weight per spike and the graph is presenting the average value per treatment.

### Results

The results showed that in seedling and a young vegetative stage (7 and 14 DAP, respectively) clethodim application did not affect normal seed production and produced the same seed amount as the control.

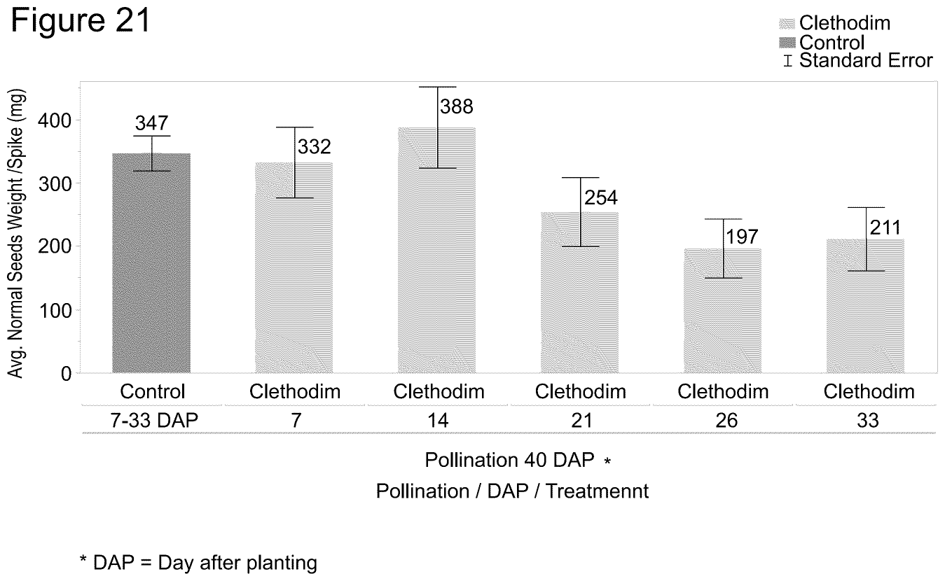

On the other hand, clethodim treatment in Mature vegetative state with induction of flowering (21 DAP) started to decrease, the decrease continued as the application stage was more advanced with a visible short main spike and no lateral inflorescence (26 DAP, p-value—0.034), Developed main with small-medium lateral inflorescence (33 DAP, p-value—0.03). All these development stages resulted in a reduction of the average normal seed weight (FIG. 21).

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method of weed control, the method comprising applying an effective amount of an Acetyl-CoA Carboxylase (ACCase) inhibitor to a broadleaf weed species of interest, wherein said applying is at a time window restricted to flowering and/or wherein said effective amount is below or above Gold standard or an amount authorized by a regulatory agency.

2-5. (canceled)

6. The method of claim 1, wherein said applying is at a time window wherein the weed species of interest is devoid of seeds.

7. (canceled)

8. The method of claim 1, wherein a predominant amount of at least 20% of plants of the weed species of interest in a growth area are at said time window at said applying.

9. The method of claim 1, wherein said broadleaf weed species is of the Amaranthus genus.

10. The method of claim 1, wherein said broadleaf weed species of interest is selected from the group consisting of Amaranthus species—A. albus, A. blitoides, A. hybridus, A. palmeri, A. powellii, A. retroflexus, A. rudis, A. spinosus, A. tuberculatus, and A. viridis; Ambrosia species—A. trifida, A. artemisifolia; Euphorbia species—E. heterophylla; Kochia species—K. scoparia; Conyza species—C. bonariensis, C. canadensis, C. sumatrensis; Plantago species—P. lanceolata, Chenopodium species—C. album; Abutilon theophrasti, Ipomoea species, Sesbania, species, Cassia species, Sida species and Solanum species.

11. The method of claim 1, wherein said broadleaf weed species of interest is selected from the group consisting of Amaranthus palmeri, Amaranthus tuberculatus, Solanum nigrum, Abutilon theophrasti and Conyza bonariensis.

12. The method of claim 1, wherein said weed control is effected at a growth area of at least an acre and optionally not exceeding 50,000 acres.

13. The method of claim 1, wherein said ACCase inhibitor is selected from the group consisting of Cyclohexanedione (DIM), Aryloxyphenoxypropionate (FOP) and Phenylpyrazolin (DEN).

14. The method of claim 1, wherein said ACCase inhibitor is clethodim.

15. The method of claim 1, wherein said ACCase inhibitor is clethodim and said effective amount is 0.05-5 g/liter.

16. (canceled)

17. The method of claim 1, wherein said applying is effected when an amount of said weed species of interest is above 40 plants/acre.

18. The method of claim 1, wherein said applying is effected in a growth area comprising crop.

19. The method of claim 18, wherein said crop is modified to comprise an ACCase inhibition resistance.

20. The method of claim 1, further comprising artificially pollinating said weed species of interest with pollen of the same species that reduces fitness of said weed species of interest, optionally wherein said pollen is irradiated.

21. The method of claim 20, wherein said applying said ACCase inhibitor is effected prior to and optionally concomitantly with said artificially pollinating.

22. The method of claim 21, wherein said applying is effected 3-14 days prior to said artificially pollinating.

23-26. (canceled)

27. The method of claim 20, wherein a regimen for said applying comprises applying said ACCase inhibitor at least once is effected prior to said artificially pollinating followed by concomitant treatment with said ACCase inhibitor and said artificially pollinating and optionally followed by artificially pollinating with or without said applying said ACCase inhibitor.

28. The method of claim 20, wherein a regimen for said applying comprises applying said ACCase inhibitor followed by said artificially pollinating at least once optionally twice or at least twice.

29-31. (canceled)

32. The method of claim 1, wherein crop environment of said weed species is selected from the group consisting of soybean, potato, corn, peanut, cotton, tomato, sunflower, rice, wheat, sugarbeet and pea.

33. The method of claim 1, wherein crop environment of said weed species is selected from the group consisting of soybean, potato, corn, peanut, cotton, tomato, sunflower, rice, wheat and sugarbeet.

34-38. (canceled)
